(19) United States
(12) Patent Application Publication
(10) Pub. No.: US 2012/0047805 A1
(43) Pub. Date: Mar. 1, 2012

(54) PANEL SUCH AS A METER BOX COVER

(75) Inventor: Earl Terence Bradley, Eastland, TX (US)

(73) Assignee: EBAA IRON, INC., Eastland, TX (US)

(21) Appl. No.: 12/985,009

(22) Filed: Jan. 5, 2011

Related U.S. Application Data
(63) Continuation-in-part of application No. 12/868,931, filed on Aug. 26, 2010.

(51) Int. Cl. E06B 3/50; E05D 7/00

(52) U.S. Cl. 49/62; 49/506

(57) ABSTRACT

A panel, such as a water meter box cover or another type of meter box cover, according to which an access door is hingedly or pivotally coupled to the panel.

### CROSS REFERENCE TO RELATED APPLICATIONS

This application is a continuation-in-part of U.S. utility patent application Ser. No. 12/868,931, filed Aug. 26, 2010, the entire disclosure of which is incorporated herein by reference.

This application is related to U.S. utility patent application Ser. No. 12/868,931, filed Aug. 26, 2010; and U.S. design patent application number 29/368,605, filed Aug. 26, 2010, the entire disclosures of which are incorporated herein by reference.

### BACKGROUND

This disclosure relates in general to a panel, such as a water meter box cover or another type of meter box cover, and an access door that is hingedly or pivotally coupled to the panel.

### BRIEF DESCRIPTION OF THE DRAWINGS

FIG. 1A is a perspective view of an apparatus according to an exemplary embodiment, the apparatus including an access door, a panel such as a meter box cover, and a pin element.

FIG. 1B is another perspective view of the apparatus of FIG. 1A, but depicts the access door in another operational position.

FIG. 2A is an exploded view of the apparatus of FIGS. 1A and 1B.

FIG. 2B is a view similar to that of FIG. 2A, but depicts the apparatus of FIGS. 1A and 1B in an unexploded condition.

FIG. 3 is a perspective view of the access door of FIGS. 1A, 1B, 2A and 2B, according to an exemplary embodiment.

FIG. 4 is another perspective view of the access door of FIG. 3.

FIG. 5 is a front elevational view of the access door of FIG. 3.

FIG. 6 is a right side elevational view of the access door of FIG. 3.

FIG. 7 is a left side elevational view of the access door of FIG. 3.

FIG. 8 is a rear elevational view of the access door of FIG. 3.

FIG. 9 is a top plan view of the access door of FIG. 3.

FIG. 10 is a bottom plan view of the access door of FIG. 3.

FIG. 11 is a sectional view of the access door of FIG. 3 taken along line 11-11 of FIG. 9.

FIG. 12 is a perspective view of a horizontally-parted mold that is used to manufacture the access door of FIGS. 1A-11, the mold including upper and lower halves, according to an exemplary embodiment.

FIG. 13 is a perspective view of a portion of the lower half of the mold of FIG. 12, according to an exemplary embodiment.

FIG. 14 is a sectional view of the access door of FIGS. 1A-11 during its manufacture using the mold of FIG. 12 according to an exemplary embodiment, the sectional view being taken along line 14-14 of FIG. 12.

FIG. 15 is another sectional view of the access door of FIGS. 1A-11 during its manufacture using the mold of FIG. 12 according to an exemplary embodiment, the sectional view being taken along line 15-15 of FIG. 12.

FIG. 16 is yet another sectional view of the access door of FIGS. 1A-11 during its manufacture using the mold of FIG. 12 according to an exemplary embodiment, the sectional view being taken along line 16-16 of FIG. 12.

FIG. 17A is a perspective view of an apparatus according to another exemplary embodiment, the apparatus including an access door, a panel such as a meter box cover, and a pin element.

FIG. 17B is another perspective view of the apparatus of FIG. 17A, but depicts the access door in another operational position.

FIG. 18A is an exploded view of the apparatus of FIGS. 17A and 17B.

FIG. 18B is a view similar to that of FIG. 18A, but depicts the apparatus of FIGS. 17A and 17B in an unexploded condition.

FIG. 19 is a top plan view of the panel of FIGS. 17A, 17B, 18A and 18B, according to an exemplary embodiment.

FIG. 19A is an enlarged view of a portion of FIG. 19.

FIG. 20 is a bottom plan view of the panel of FIG. 19.

FIG. 21 is a sectional view of the panel of FIG. 19 taken along line 21-21 of FIG. 19.

FIG. 22 is a sectional view of the panel of FIG. 19 taken along line 22-22 of FIG. 19.

FIG. 23 is a sectional view of the panel of FIG. 19 taken along line 23-23 of FIG. 19.

FIG. 24 is a perspective view of a portion of the panel of FIG. 19.

FIG. 25 is a perspective view of another portion of the panel of FIG. 19.

FIG. 26 is a perspective view of a horizontally-parted mold that is used to manufacture the panel of FIGS. 17A-25, the mold including upper and lower halves, according to an exemplary embodiment.

FIG. 27 is a sectional view of the panel of FIGS. 17A-25 during its manufacture using the mold of FIG. 26 according to an exemplary embodiment, the sectional view being taken along line 27-27 of FIG. 26.

FIG. 28 is another sectional view of the panel of FIGS. 17A-25 during its manufacture using the mold of FIG. 26 according to an exemplary embodiment, the sectional view being taken along line 28-28 of FIG. 26.

### DETAILED DESCRIPTION

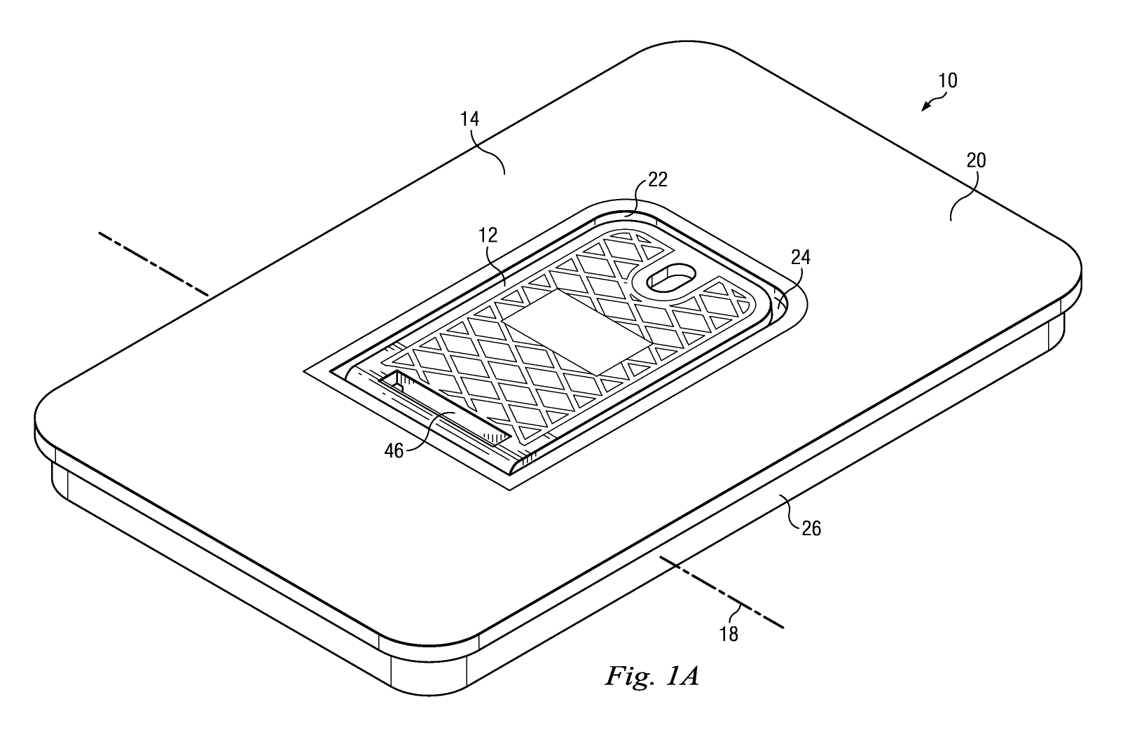

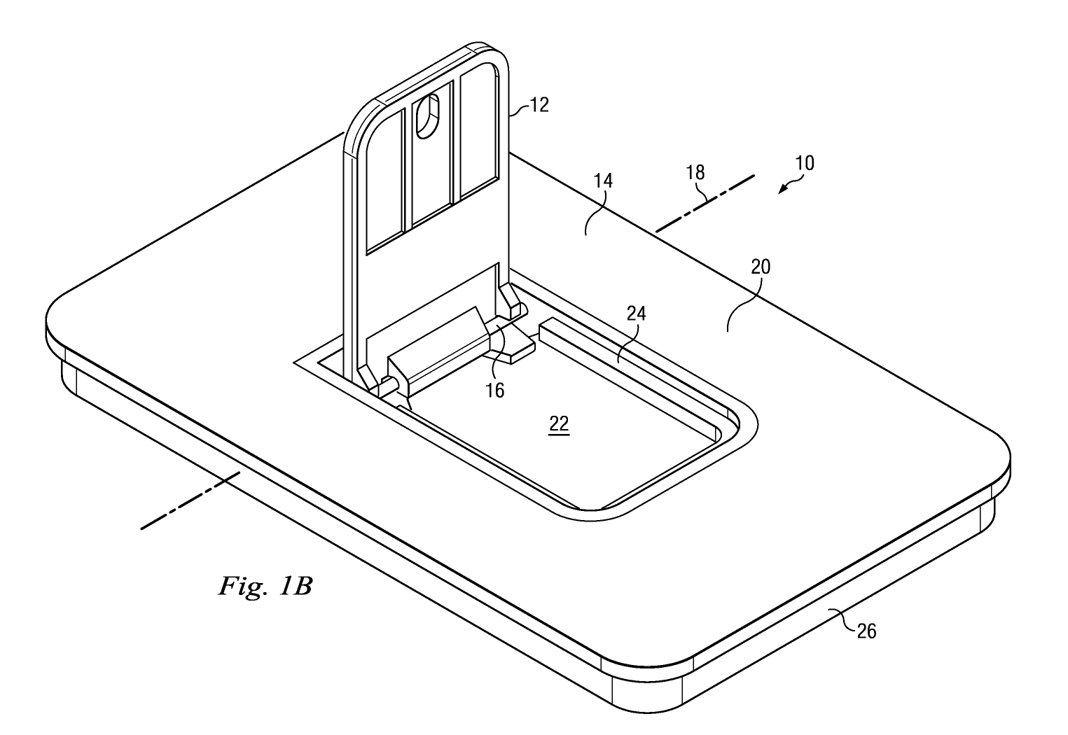

In an exemplary embodiment, as illustrated in FIGS. 1A and 1B, an apparatus is generally referred to by the reference numeral 10 and includes a generally rectangular access door 12, which is hingedly or pivotally coupled to a panel 14 via a pin element 16 (shown in FIG. 1B). A pivot axis 18 is defined in part by the access door 12. Under conditions to be described in detail below, the access door 12 is adapted to pivot, relative to the panel 14, about the pivot axis 18 and between a closed position shown in FIG. 1A and an open position shown in FIG. 1B. In an exemplary embodiment, the panel 14 is a meter box cover such as, for example, a water meter box cover. In an exemplary embodiment, each of the access door 12 and the panel 14 is formed of cast metal, such as ductile iron. In several exemplary embodiments, instead of, or in addition to cast metal, the access door 12 and/or the panel 14 is formed of one or more other materials such as, for example, one or more thermoplastic or thermoset materials.

The panel 14 includes a plate or wall 20 and a generally rectangular opening 22 formed therethrough. At least a portion of the access door 12 is disposed in the opening 22, regardless of the pivot position of the access door 12 relative to the panel 14. A generally U-shaped internal shoulder 24 is disposed within the opening 22, and faces a direction so that the access door 12 is adapted to engage or nearly engage the shoulder 24 when the access door 12 is in the closed position shown in FIG. 1A. A peripheral flange 26 depends from the wall 20.

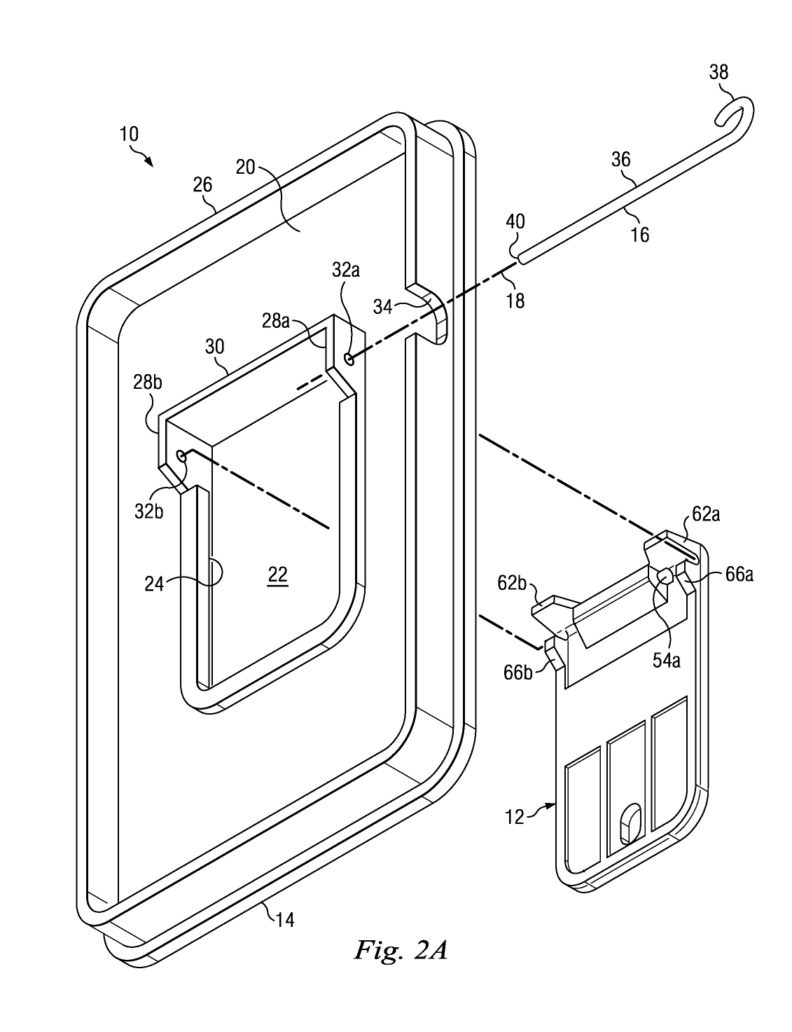

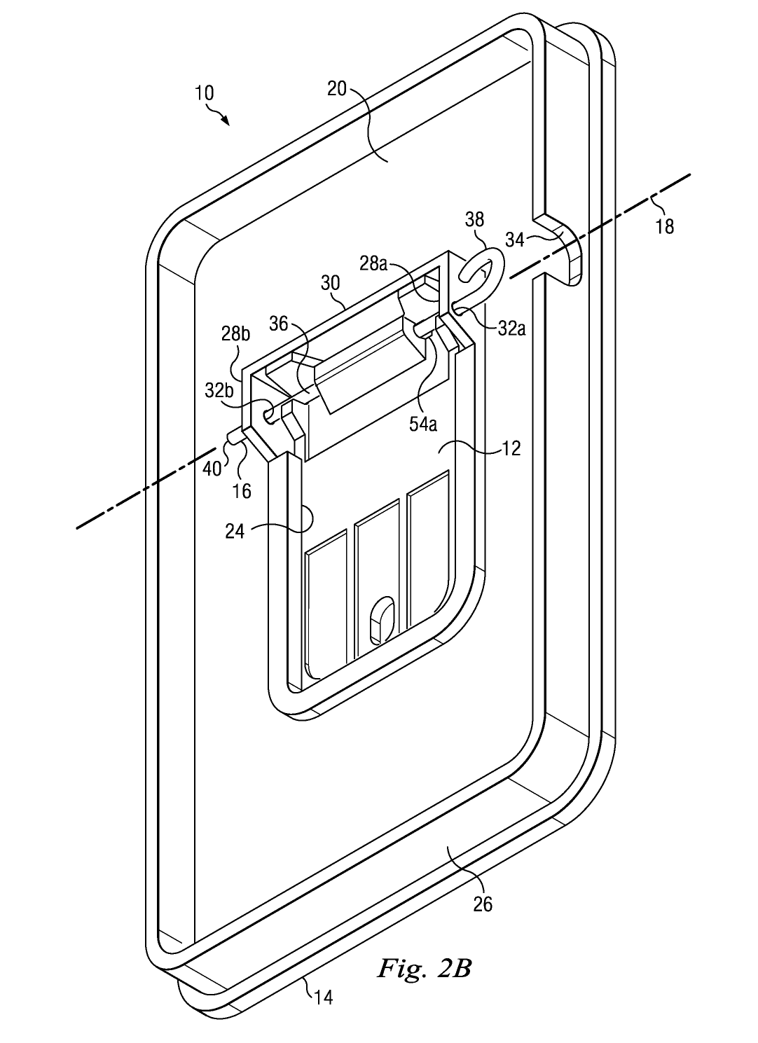

In an exemplary embodiment, as illustrated in FIGS. 2A and 2B with continuing reference to FIGS. 1A and 1B, the panel 14 further includes opposed walls 28a and 28b, which are aligned with opposed edges of the opening 22, respectively, and extend away from the wall 20 in a direction generally opposite the direction which the internal shoulder 24 faces. A wall 30 is also aligned with another edge of the opening 22, and extends between the walls 28a and 28b. Axially-aligned openings 32a and 32b are formed through the opposed walls 28a and 28b, respectively. A notch 34 is formed in the flange 26, and is axially aligned with the openings 32a and 32b. The notch 34 and the openings 32a and 32b are generally coaxial with the pivot axis 18.

The pin element 16 includes a pin or rod portion 36, a hooked end portion 38, and a non-hooked end portion 40 that is opposite the hooked end portion 38. The rod portion 36, the non-hooked end portion 40, and the openings 32a and 32b, are each sized so that the rod portion 36 is permitted to extend through the openings 32a and 32b, under conditions to be described below. The notch 34 is sized to permit the pin element 16, including the hooked end portion 38, to pass through the notch 34, under conditions to be described below. In an exemplary embodiment, the pin element 16 is formed of a wire having a diameter that permits the rod portion 36 to extend through the openings 32a and 32b. In an exemplary embodiment, the pin element 16 is formed of ¼-inch wire or another size of wire. In an exemplary embodiment, instead of, or in addition to a wire, the pin element 16 is, or includes, a fastener.

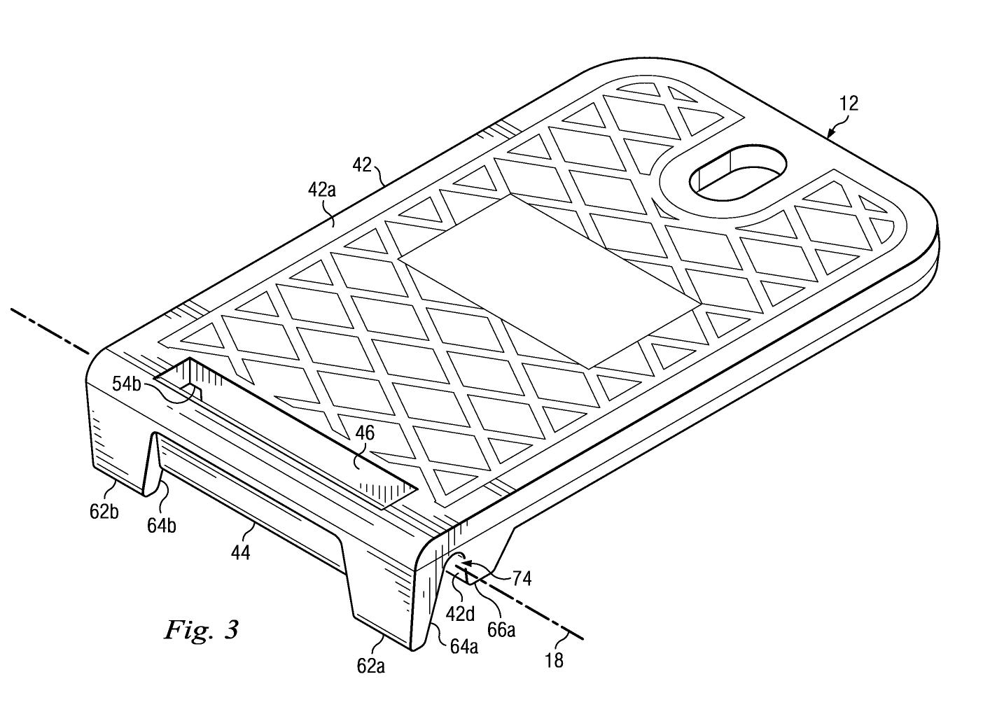

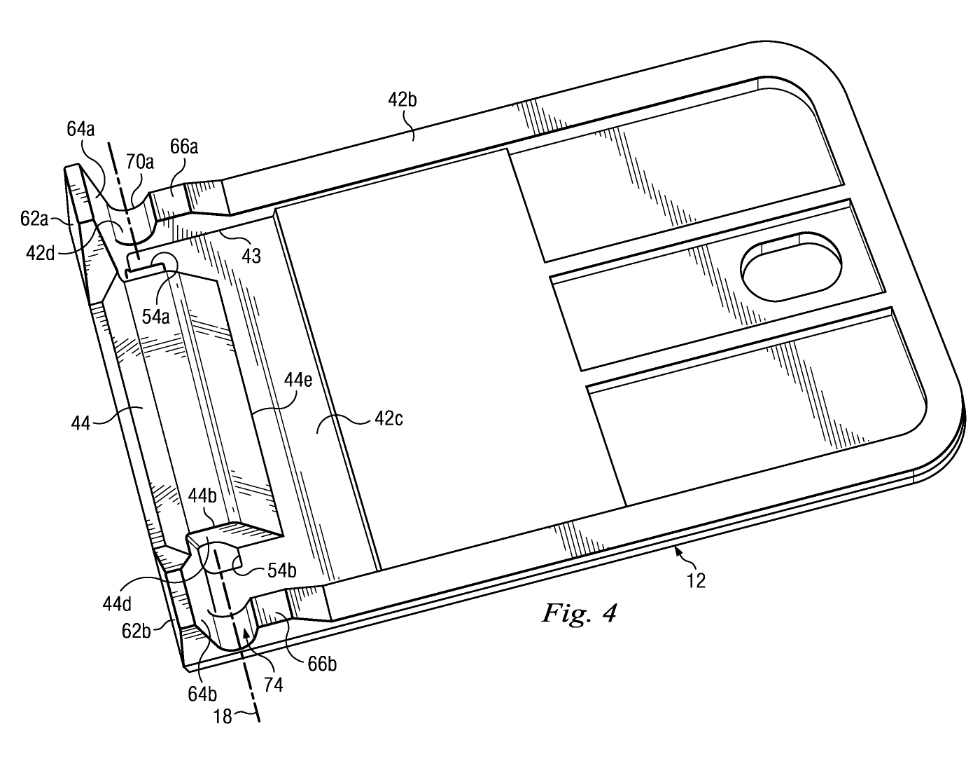

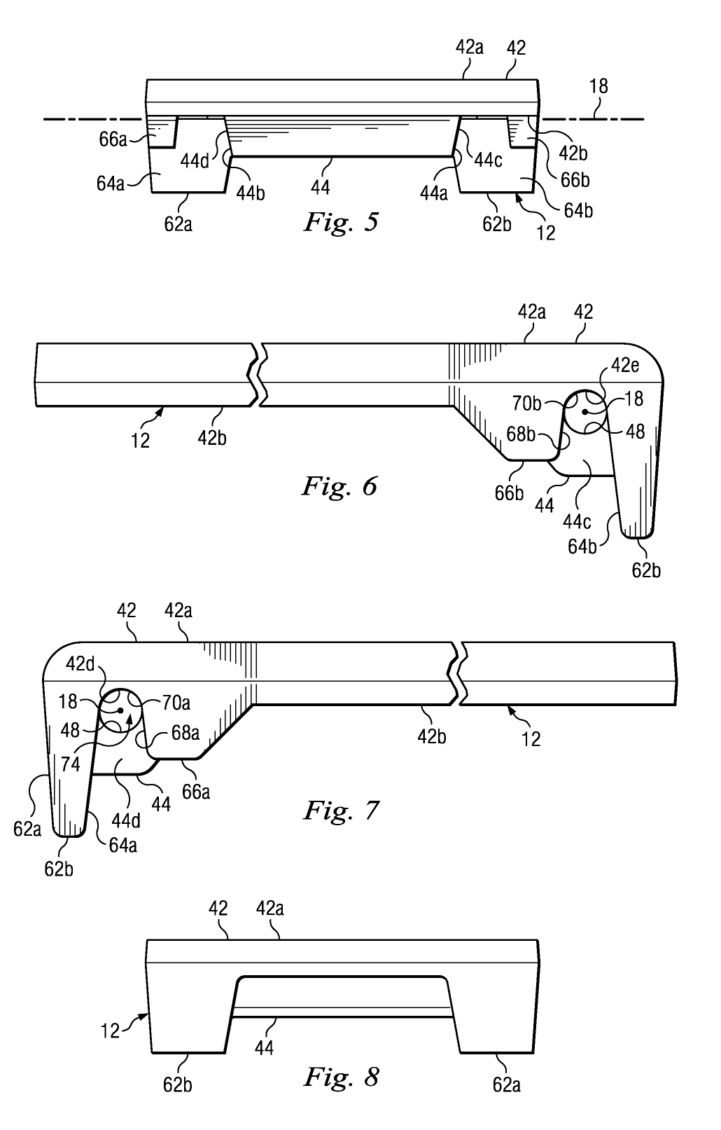

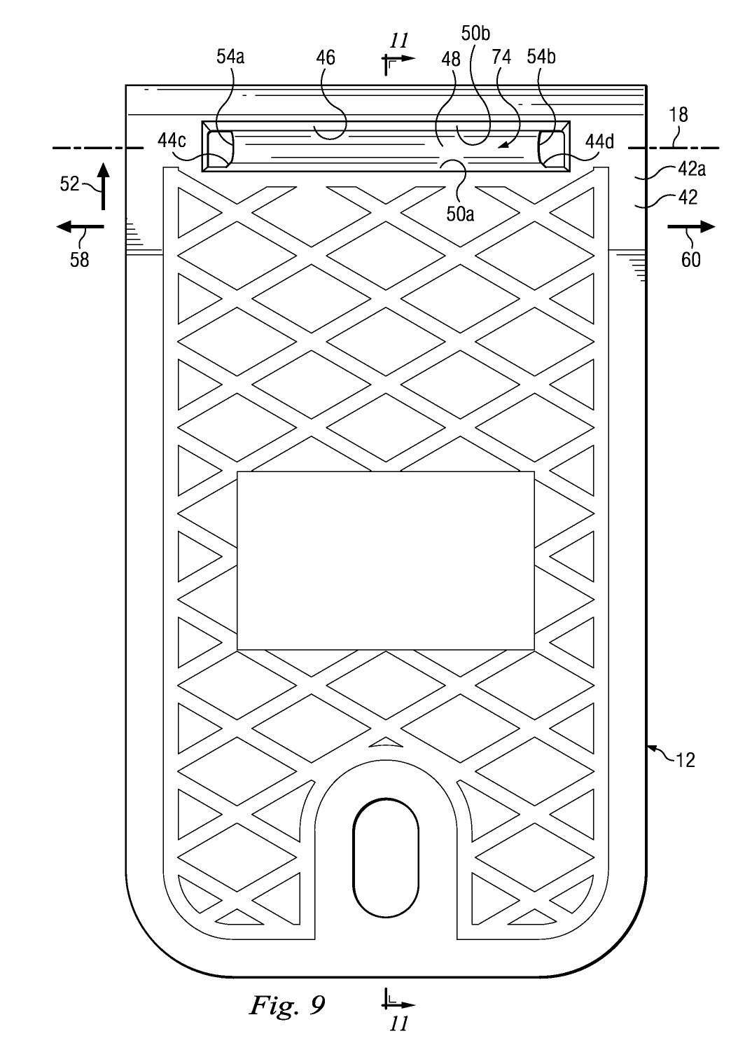

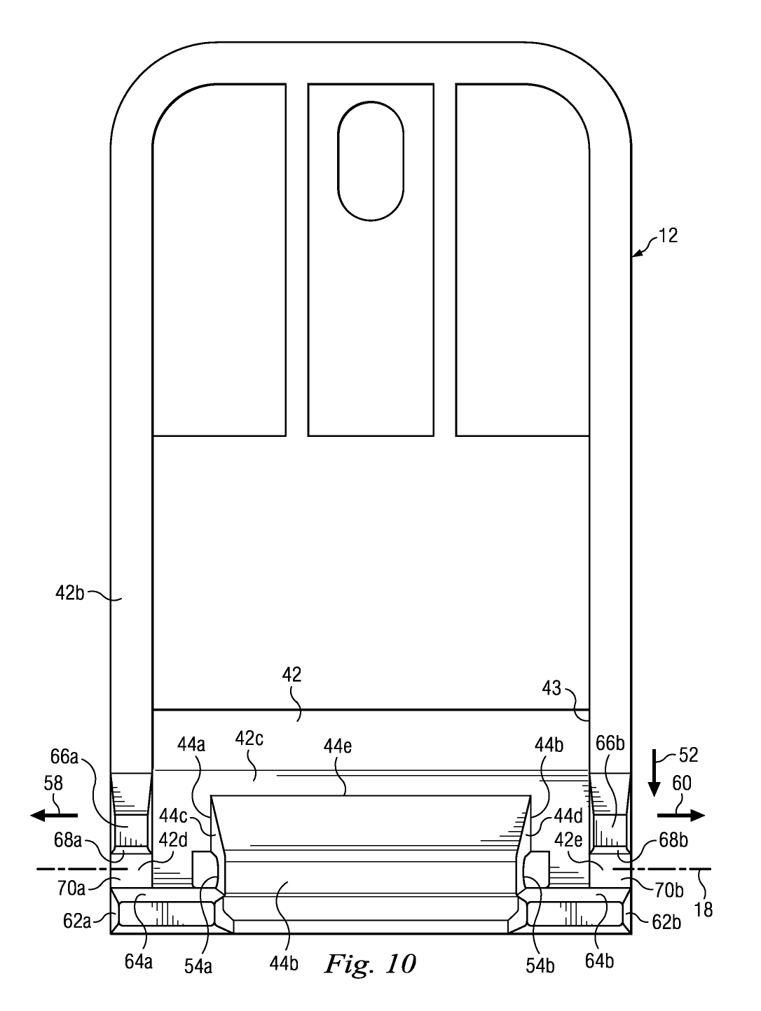

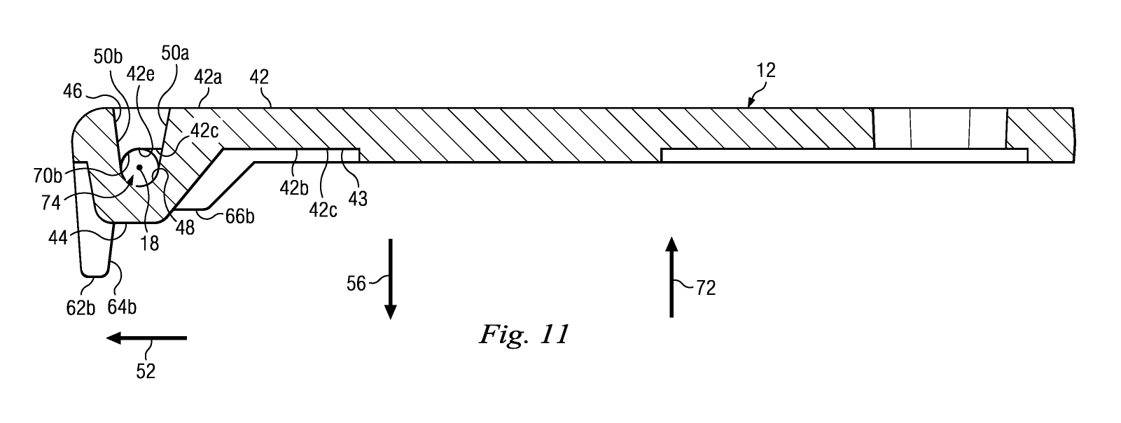

In an exemplary embodiment, as illustrated in FIGS. 3-11 with continuing reference to FIGS. 1A, 1B, 2A and 2B, the access door 12 includes a plate 42 defining parallel-spaced sides 42a and 42b. A recess 43 is formed in the side 42b, and defines a horizontally-extending surface 42c on the side 42b of the plate 42. A ridge 44 extends from the horizontally-extending surface 42c and along the side 42b, and includes opposing end portions 44a and 44b. Angularly-extending end faces 44c and 44d are defined by the opposing end portions 44a and 44b, respectively, so that the ridge 44 is longest at a base 44e thereof which extends along the horizontally-extending surface 42c on the side 42b of the plate 42, as most clearly shown in FIGS. 4 and 10. A channel 46 is formed in the side 42a of the plate 42, and extends into the ridge 44 and axially therealong. An axially-extending internal concave surface 48 of the ridge 44 is defined by the channel 46. Surfaces 50a and 50b are also defined by the channel 46, and extend angularly inward and towards each other from the side 42a of the plate 42. The angularly-extending surface 50b is spaced from the angularly-extending surface 50a in a direction 52 (shown in FIGS. 9 and 11) that is generally perpendicular to the pivot axis 18. The angularly-extending surfaces 50a and 50b are part of the plate 42 and the ridge 44. The concave surface 48 joins the distal ends of the surfaces 50a and 50b so that the surfaces 48, 50a and 50b are generally continuous.

Opposing openings 54a and 54b are formed through the plate 42, and further through the opposing end portions 44a and 44b, respectively, of the ridge 44, as clearly shown in FIGS. 4, 9 and 10. More particularly, the opening 54a extends through the plate 42 and the end portion 44a in a direction 56 (shown FIG. 11) that is generally perpendicular to the pivot axis 18. The opening 54a also extends from the channel 46 and through the end portion 44a of the ridge 44 in a direction 58 (shown in FIGS. 9 and 10), which is generally parallel to the pivot axis 18. Similarly, the opening 54b extends through the plate 42 and the end portion 44b in the direction 56, and also extends from the channel 46 and through the end portion 44b of the ridge 44 in a direction 60 (shown in FIGS. 9 and 10), which is generally parallel to the pivot axis 18.

Opposing tabs 62a and 62b extend from the side 42b of the plate 42. The tabs 62a and 62b defines angularly-extending surfaces 64a and 64b, respectively. The surface 64a shares an edge with the end face 44c of the ridge 44, and is adjacent a portion of the opening 54a. Similarly, the surface 64b shares an edge with the end face 44d of the ridge 44, and is adjacent a portion of the opening 54b. At least the great majority the ridge 44 is axially positioned between the tabs 62a and 62b. Opposing ears 66a and 66b extend from the side 42b of the plate 42. The ears 66a and 66b define angularly-extending surfaces 68a and 68b, respectively. The surface 64a of the tab 62a is spaced from the surface 68a of the ear 66a in the direction 52. Likewise, the surface 64b of the tab 62b is spaced from the surface 68b of the ear 66b in the direction 52.

Notches 70a and 70b are formed in the second side 42b of the plate 42. The notches 70a and 70b define axially-aligned concave surfaces 42d and 42e, respectively, of the plate 42. The concave surface 42d extends between the surfaces 64a and 68a. Likewise, the concave surface 42e extends between the surfaces 64b and 68b. At least respective portions of the concave surfaces 42d and 42e are spaced from the concave surface 48 of the ridge 44 in a direction 72 (shown in FIG. 11), which is generally perpendicular to the pivot axis 18 and opposite to the direction 56. The concave surface 42d is axially spaced from the concave surface 48 in the direction 58 along the pivot axis 18. Similarly, the concave surface 42e is axially spaced from the concave surface 48 in the direction 60 along the pivot axis 18. As a result, the concave surface 48 is axially positioned between the concave surfaces 42d and 42e.

The surface 42c of the plate 42 is spaced from the concave surface 48 of the ridge 44 in the direction 72. The concave surface 48 is axially positioned between respective portions of the surface 42c, with one portion extending axially between the opening 54a and the notch 70a, and the other portion extending axially between the opening 54b and the notch 70b.

As most clearly shown in FIGS. 6 and 11, the concave surfaces 42e and 48 are spaced from one another, in either the direction 56 or 72, so that their respective centers of curvature lie generally along the pivot axis 18. As a result, the concave surfaces 42e and 48 are vertically positioned, relative to one another, so that the surfaces 42e and 48 would form a generally circular cross section with the pivot axis 18 generally at its center, but for the axial spacing between the surfaces 42e and 48 along the pivot axis 18. Likewise, as shown in FIG. 7, the concave surfaces 42d and 48 are vertically positioned, relative to one another, so that the surfaces 42d and 48 would form a generally circular cross section with the pivot axis 18 generally at its center, but for the axial spacing between the surfaces 42d and 48 along the pivot axis 18.

An axially-extending passage 74 is defined by at least the concave surfaces 42d, 48 and 42e, and is generally coaxial with the pivot axis 18. The passage 74 includes the notch 70a, the opening 54a, the channel 46, the opening 54b and the notch 70b.

In an exemplary embodiment, the access door 12 is integrally formed and thus the plate 42, the ridge 44, the tabs 62 and 62b, and the ears 66a and 66b, are integrally formed. In an exemplary embodiment, the access door 12 is a casting and thus is integrally formed of cast metal, such as ductile iron. In several exemplary embodiments, instead of, or in addition to cast metal, the access door 12 is integrally formed of one or more other materials such as, for example, one or more thermoplastic or thermoset materials.

In an exemplary embodiment, with continuing reference to FIGS. 1A-11, to place the apparatus 10 in its assembled condition as shown in FIGS. 1A, 1B and 2B, the access door 12 is positioned, relative to the panel 14, so that: each of the tabs 62a and 62b of the access door 12 is adjacent the wall 30 of the panel 14, the ears 66a and 66b are adjacent the walls 28a and 28b, respectively, and the axially-extending passage 74 is axially positioned between, and aligned with, the axially-aligned openings 32a and 32b. The pin element 16 is passed through the notch 34 so that the non-hooked end portion 40 is inserted through the axially-aligned opening 32a, the passage 74 and the opening 32b. The hooked end portion 38 of the pin element 16 prevents the pin element 16 from passing completely through the opening 32a. As a result, the rod portion 36 of the pin element 16 extends through the opening 32a, the passage 74, and the opening 32b, thereby hingedly or pivotally coupling the access door 12 to the panel 14. The rod portion 36, the passage 74 and the openings 32a and 32b are all generally coaxial with the pivot axis 18.

In operation, in an exemplary embodiment, with continuing reference to FIGS. 1A-11, after the apparatus 10 has been placed in its assembled condition as described above, the access door 12 pivots, relative to the panel 14, about the pivot axis 18. The access door 12 pivots between the closed position shown in FIG. 1A and the open position shown in FIG. 1B. When the access door 12 is in the closed position shown in FIG. 1A, the side 42b of the plate 42 engages or nearly engages the shoulder 24 and the tabs 62a and 62b engage or nearly engage the wall 30, thereby resisting any further pivoting of the access door 12 in a clockwise direction, as viewed in FIGS. 1A and 1B, after the access door 12 has been placed in the closed position shown in FIG. 1A. When the access door 12 is in the open position shown in FIG. 1B, the side 42a of the plate 42 engages or nearly engages the panel 14 at the edge of the opening 22 that is aligned with the wall 30, thereby resisting any further pivoting of the access door 12 in a counterclockwise direction, as viewed in FIGS. 1A and 1B.

During the pivoting of the access door 12 relative to the panel 14, the respective shapes of the concave surfaces 48, 42d and 42e minimize any resistance to the pivoting of the access door 12 about the rod portion 36 of the pin element 16, thereby facilitating the pivoting of the access door 12. Further, the positioning of the respective centers of curvature of the concave surfaces 42d, 42e and 48 along the pivot axis 18 minimizes any resistance to the pivoting of the access door 12 about the rod portion 36 of the pin element 16, thereby facilitating the pivoting of the access door 12.

In several exemplary embodiments, before, during and/or after the above-described exemplary operation of the apparatus 10, the extension of the pin element 16 through the opening 32a, the passage 74 and the opening 32b, maintains the pivotal coupling between the access door 12 and the panel 14. For example, the extension of the pin element 16 between the surfaces 50a and 50b resists any movement of the access door 12, relative to the pin element 16 and thus the panel 14, in the direction 52 or a direction opposite thereof, regardless of the pivot position of the access door 12. For another example, the extension of the pin element 16 between the surfaces 64a and 68a, and between the surfaces 64b and 68b, resists any movement of the access door 12, relative to the pin element 16 and thus the panel 14, in the direction 52 or a direction opposite thereof, regardless of the pivot position of the access door 12. For still another example, the extension of the pin element 16 between the concave surface 48 and the concave surfaces 42d and 42e resists any movement of the access door 12, relative to the pin element 16 and thus the panel 14, in either the direction 56 or the direction 72, regardless of the pivot position of the access door 12. For still yet another example, if the concave surfaces 42d and 42e were omitted in an exemplary embodiment, the extension of the pin element 16 between the concave surface 48 and the respective portions of the surface 42c adjacent the openings 54a and 54b would resist any movement of the access door 12, relative to the pin element 16 and thus the panel 14, in either the direction 56 or the direction 72, regardless of the pivot position of the access door 12.

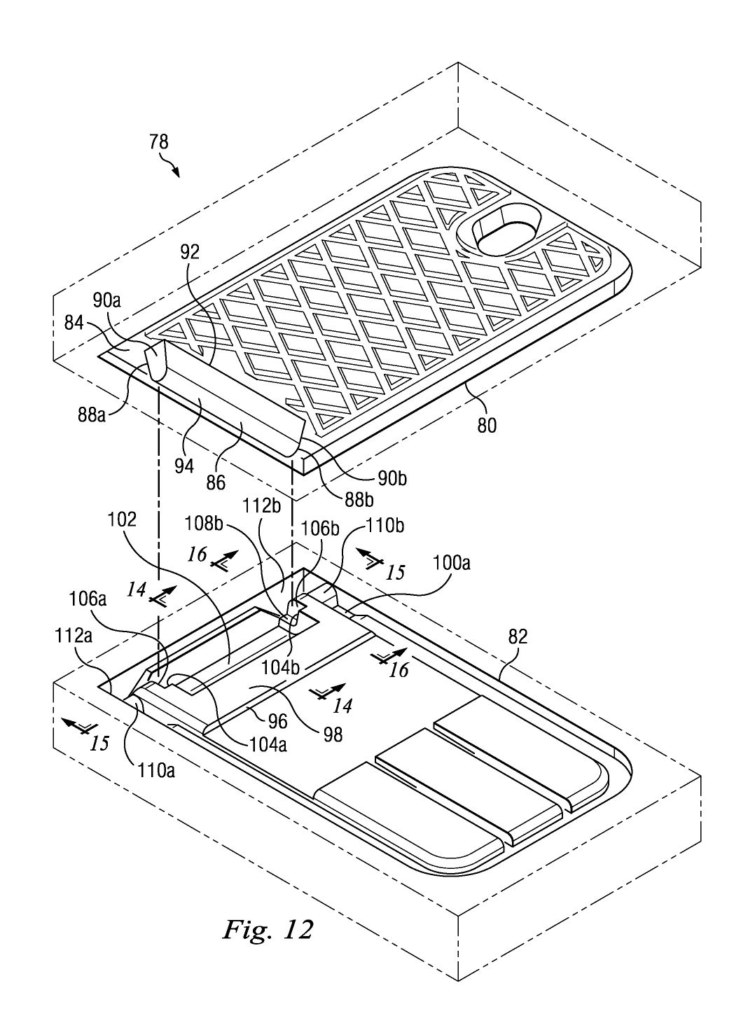

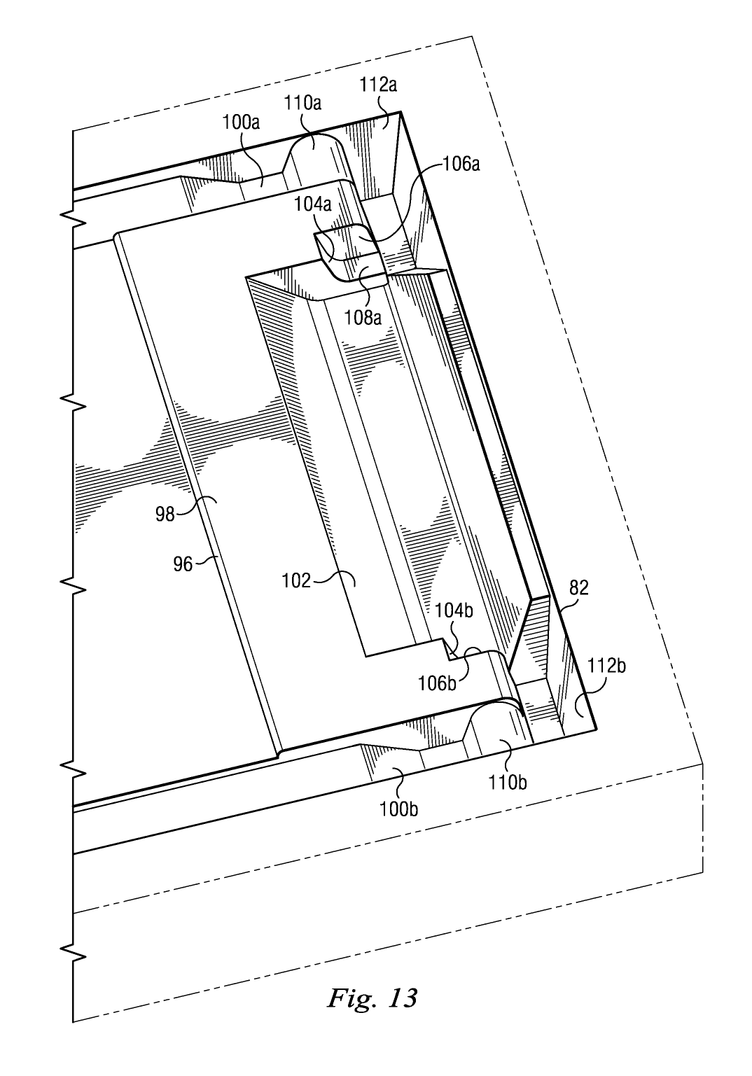

In an exemplary embodiment, as illustrated in FIGS. 12 and 13 with continuing reference to FIGS. 1A-11, a horizontally-parted mold is generally referred to by the reference numeral 78 and includes an upper part, such as an upper half or cope 80, and a lower part, such as a lower half or drag 82. The mold 78 is used to manufacture the access door 12 of FIGS. 1A-11. As shown in FIGS. 12 and 13, the mold 78 does not include any cores such as, for example, hinge tubes or other cores, therein. In several exemplary embodiments, in addition to the cope 80 and the drag 82, the mold 78 includes, and/or employs, one or more gates, runner systems, etc., but does not include any cores, such as hinge tubes or other cores, therein. The broken line illustrations in FIGS. 12 and 13, and FIGS. 14-16 discussed below, indicate that the mold 78 includes additional structure other than the cope 80 and the drag 82.

The cope 80 includes a horizontally-extending surface 84 from which a rib 86 extends. The rib 86 includes opposing end portions 88a and 88b, which define angularly-extending end faces 90a and 90b, respectively. The end faces 90a and 90b extend from the surface 84 angularly towards one another so that the rib 86 is longest at a base 92 thereof which extends along the surface 84. The rib 86 includes a convex surface 94 at its distal end.

The drag 82 includes a raised portion 96 that defines a horizontally-extending surface 98, openings 100a and 100b on either side of the raised portion 96, and an axially-extending channel 102 formed in the raised portion 96. Notches 104a and 104b are formed in the raised portion 96 at opposing ends of the channel 102, respectively. The notches 104a and 104b define angularly-extending surfaces 106a and 106b, respectively, which extend from the surface 98 and inwardly towards one another to surfaces 108a and 108b, respectively. Axially-aligned convex surfaces 110a and 110b are formed on either side of the raised portion 96, and are adjacent the openings 100a and 100b, respectively. Openings 112a and 112b are adjacent the convex surfaces 110a and 110b, respectively. As a result, the convex surface 110a extends between the openings 100a and 112a. Similarly, the convex surface 110b extends between the openings 100b and 112b.

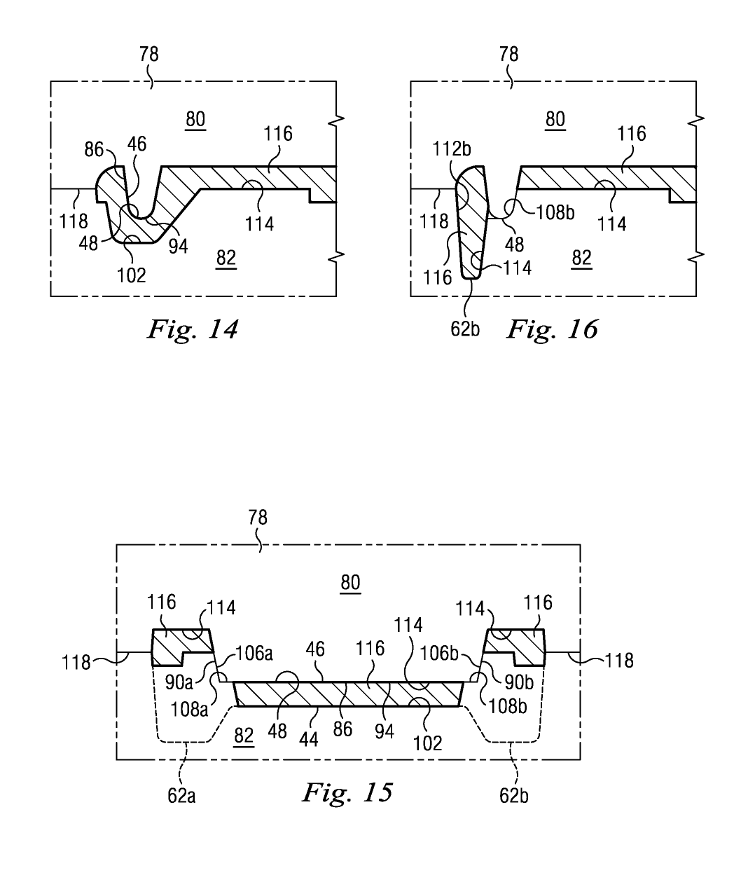

In an exemplary embodiment, as illustrated in FIGS. 14-16 with continuing reference to FIGS. 1A-13, to manufacture of the access door 12, the access door 12 is cast using the mold 78 and without a core in the mold 78. More particularly, the cope 80 is engaged with the drag 82 to form the mold 78. The mold 78 defines a cavity 114 therein, portions of which are shown in FIGS. 14-16. The cavity 114 includes at least respective portions of the channel 102 and the openings 100a, 100b, 112a and 112b. Before, during and/or after the engagement between the cope 80 and the drag 82, the cavity 114 is filled with a material 116 such as, for example, molten metal. The cope 80 and the drag 82 engage one another, or at least are proximate to each other, generally along a horizontally-extending part line 118.

As shown in FIGS. 14 and 15, before, during and/or after the engagement between the cope 80 and the drag 82 and/or the filling of the cavity 114 with the material 116, the rib 86 extends within the channel 102. A portion of the channel 102 not taken up by the rib 86 forms the ridge 44 of the access door 12. The rib 86 forms the channel 46 of the access door 12, with the convex surface 94 forming the concave surface 48 of the access door 12.

As shown in FIGS. 15 and 16, before, during and/or after the engagement between the cope 80 and the drag 82 and/or the filling of the cavity 114 with the material 116, the opposing end portions 88a and 88b of the rib 86 extend into the notches 104a and 104b, respectively. The angularly-extending end face 90a of the rib 86 engages the angularly-extending surface 106a, and the convex surface 94 of the rib 86 engages the surface 108a. As a result, the opening 54a of the access door 12 is formed, with the opening 54a extending through the plate 42 and the end portion 44a in the direction 56 (shown FIG. 11), and also extending from the channel 46 and through the end portion 44a of the ridge 44 in the direction 58 (shown in FIGS. 9 and 10), as described above. Similarly, the angularly-extending end face 90b of the rib 86 engages the angularly-extending surface 106b, and the convex surface 94 of the rib 86 engages the surface 108b. As a result, the opening 54b of the access door 12 is formed, with the opening 54b extending through the plate 42 and the end portion 44b in the direction 56, and also extending from the channel 46 and through the end portion 44b of the ridge 44 in the direction 60 (shown in FIGS. 9 and 10), as described above. As further shown in FIGS. 15 and 16, before, during and/or after the engagement between the cope 80 and the drag 82 and/or the filling of the cavity 114 with the material 116, the tabs 62a and 62b of the access door 12 are formed at least in part by the material 116 filing the openings 112a and 112b, respectively.

Before, during and/or after the engagement between the cope 80 and the drag 82 and/or the filling of the cavity 114 with the material 116, the ears 66a and 66b of the access door 12 are formed at least in part by the material 116 filling the openings 100a and 100b, respectively. The notch 70a and the concave surface 42d of the access door 12 are formed at least in part by the material 116 filling the openings 100a and 112a and another portion of the cavity 114 that extends across the convex surface 110a. Similarly, the notch 70b and the concave surface 42e of the access door 12 are formed at least in part by the material 116 filling the openings 100b and 112b and another portion of the cavity 114 that extends across the convex surface 110b. The recess 43 of the access door 12 is formed at least in part by the material 116 filling the portion of the cavity 114 that extends across the raised portion 96, with the surface 98 of the drag 82 defining the surface 42c of the access door 12.

As a result of the above-described manufacture of the access door 12 by casting the access door 12 using the mold 78, the axially-extending passage 74 of the access door 12 is formed without the use of a core in the mold 78, with the passage 74 being defined by at least the concave surfaces 42d, 48 and 42e, being generally coaxial with the pivot axis 18, and including the notch 70a, the opening 54a, the channel 46, the opening 54b and the notch 70b. Therefore, in response to manufacturing the access door 12 by casting the access door 12 using the mold 78 without a core in the mold 78, the passage 74 is formed such that the pin element 16 may be inserted through the passage 74, without the need for any drilling or machining of the access door 12. The elimination of the need for post-casting drilling or machining of the access door 12 means the access door 12 is much less costly to manufacture. The access door 12 is ready to be hingedly or pivotally coupled to the panel 14, as cast.

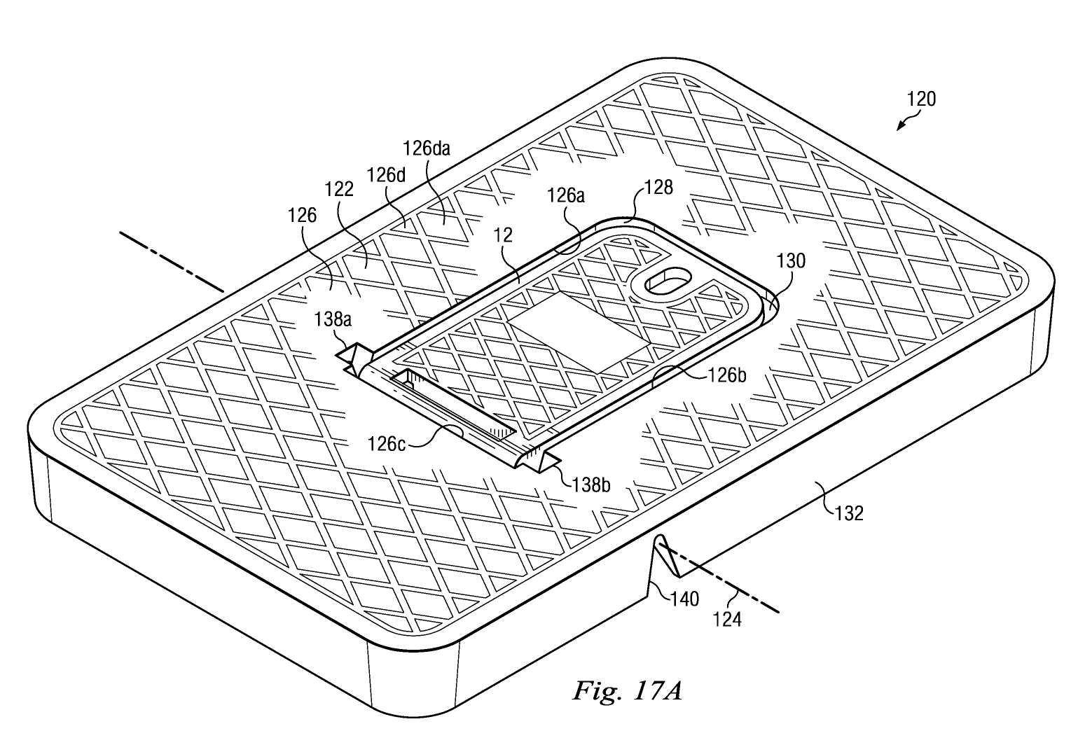

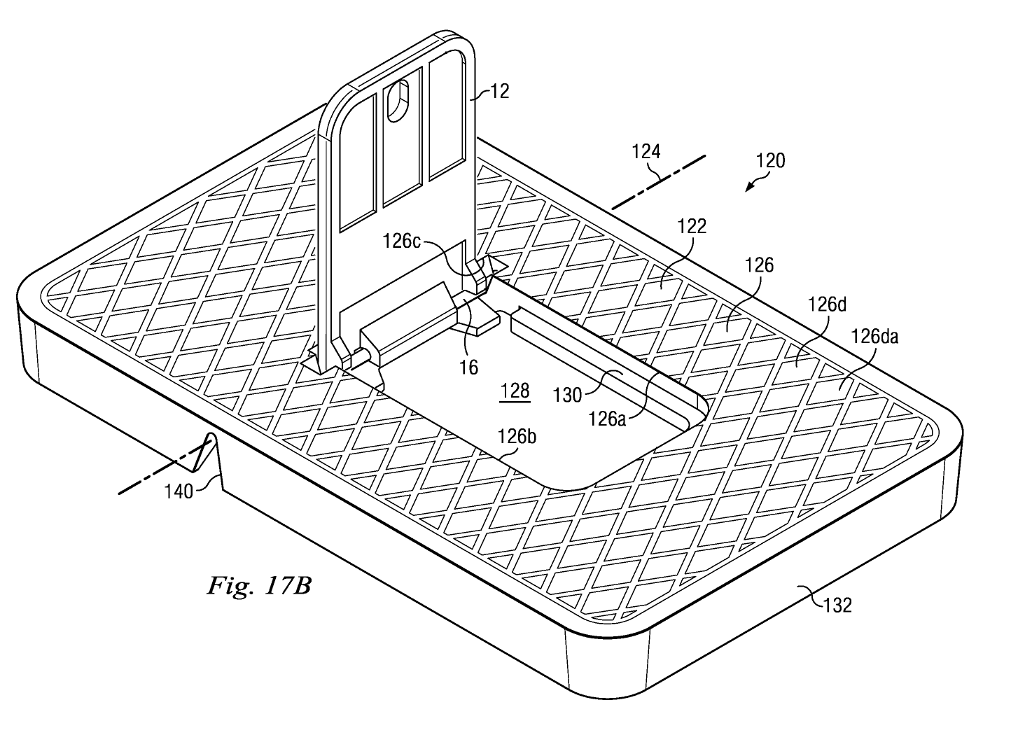

In an exemplary embodiment, as illustrated in FIGS. 17A and 17B, an apparatus is generally referred to by the reference numeral 120 and includes several parts of the apparatus 10, which parts are given the same reference numerals.

As shown in FIGS. 17A and 17B, the apparatus 120 includes the access door 12, which is hingedly or pivotally coupled to a panel 122 via the pin element 16 (shown in FIG. 17B). A pivot axis 124 is defined in part by the access door 12. The pivot axis 124 is generally coaxial with the pivot axis 18 (not shown in FIGS. 17A and 17B) and the pin element 16. Under conditions to be described in detail below, the access door 12 is adapted to pivot, relative to the panel 122, about the pivot axis 124 and between a closed position shown in FIG. 17A and an open position shown in FIG. 17B. In an exemplary embodiment, the panel 122 is a meter box cover such as, for example, a water meter box cover. In an exemplary embodiment, each of the access door 12 and the panel 122 is formed of cast metal, such as ductile iron. In several exemplary embodiments, instead of, or in addition to cast metal, the access door 12 and/or the panel 122 is formed of one or more other materials such as, for example, one or more thermoplastic or thermoset materials.

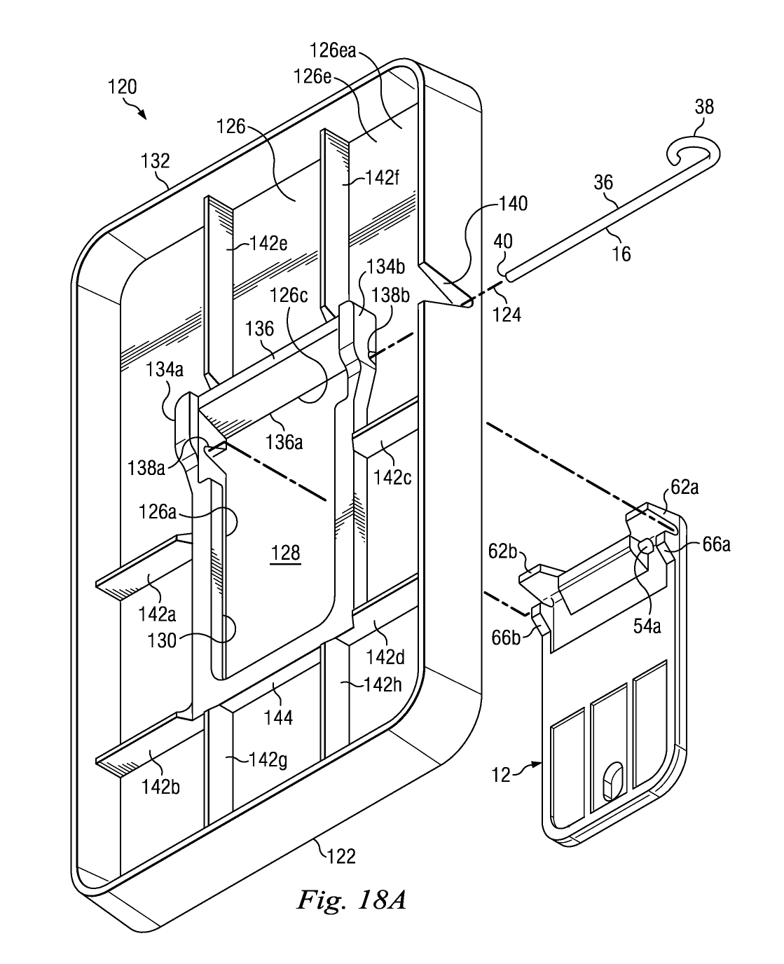

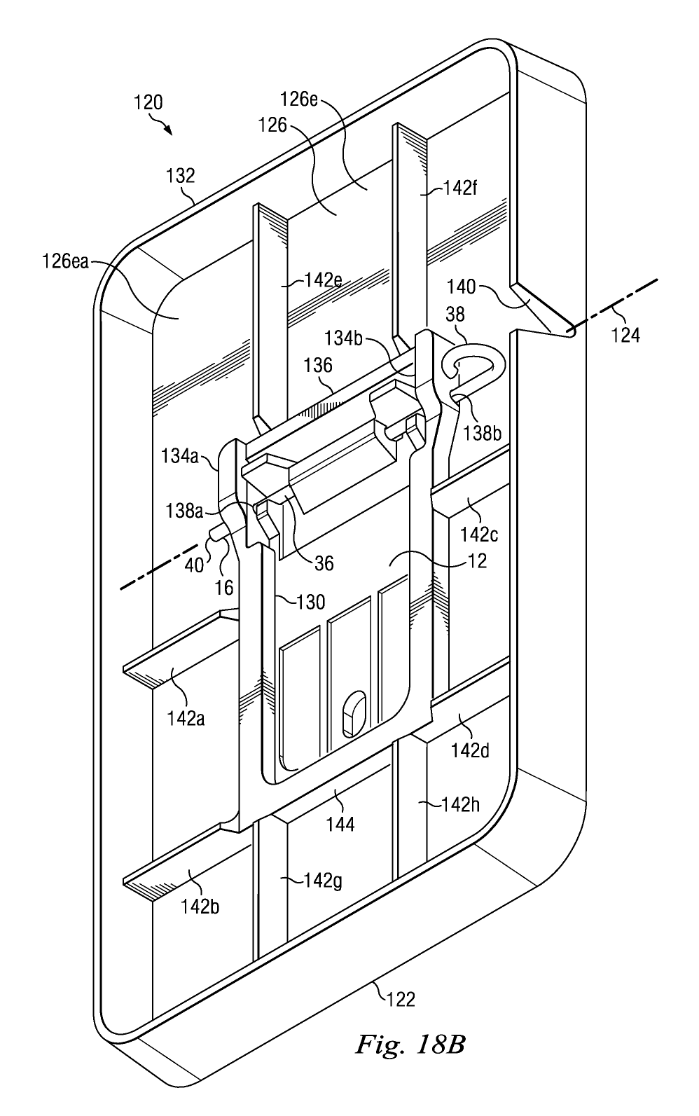

The panel 122 includes a wall or plate 126 and a generally rectangular opening 128 formed therethrough. The opening 128 defines opposing edges 126a and 126b of the plate 126. The edges 126a and 126b are spaced in a parallel relation. The opening 128 further defines an edge 126c, which extends between, and is generally perpendicular to, the opposing edges 126a and 126b. The plate 126 further defines parallel-spaced sides 126d and 126e, which define horizontally-extending surfaces 126da and 126ea, respectively (the side 126e and the surface 126ea are first shown in FIG. 18A). At least a portion of the access door 12 is disposed in the opening 128, regardless of the pivot position of the access door 12 relative to the panel 122. A generally U-shaped internal shoulder 130 is disposed within the opening 128, and faces a direction so that the access door 12 is adapted to engage or nearly engage the shoulder 130 when the access door 12 is in the closed position shown in FIG. 17A. A peripheral flange 132 depends from the plate 126.

In an exemplary embodiment, as illustrated in FIGS. 18A and 18B with continuing reference to FIGS. 17A and 17B, the panel 122 further includes opposed walls 134a and 134b, which are aligned with the opposed edges 126a and 126b, respectively, of the plate 126. Each of the opposed walls 134a and 134b extends away from the side 126d of the plate 126 in a direction generally opposite the direction which the internal shoulder 130 faces. As a result, the portion of the panel 122 that constitutes the intersection between the plate 126 and the wall 134a may be considered to be part of each of the plate 126 and the wall 134a. Likewise, the portion of the panel 122 that constitutes the intersection between the plate 126 and the wall 134b may be considered to be part of each of the plate 126 and the wall 134b. An edge 136a of a wall 136 is aligned with the edge 126c of the plate 126, and the wall 136 extends between the walls 134a and 134b. Openings 138a and 138b extend from the side 126d, through the plate 126, and into the opposed walls 134a and 134b, respectively. The openings 138a and 138b will be described in further detail below. A notch 140 is formed in the flange 132, and is axially aligned with respective portions of the openings 138a and 138b. The notch 140 and respective portions of the openings 138a and 138b are generally coaxial with the pivot axis 124. Ribs 142a and 142b extend along the plate 126 and between the flange 132 and the wall 134a. Ribs 142c and 142d extend along the plate 126 and between the flange 132 and the wall 134b. Ribs 142e and 142f extend along the plate 126 and between the flange 132 and the wall 136. Ribs 142g and 142h extend along the plate 126 and between the flange 132 and a wall 144, which opposes the wall 136 and extends between the walls 134a and 134b.

As shown in FIG. 18B, the rod portion 36 and the non-hooked end portion 40 of the pin element 16, and the openings 138a and 138b, are each sized so that the rod portion 36 is permitted to extend through the openings 138a and 138b, under conditions to be described below. The notch 140 is sized to permit the pin element 16, including the hooked end portion 38, to pass through the notch 140, under conditions to be described below.

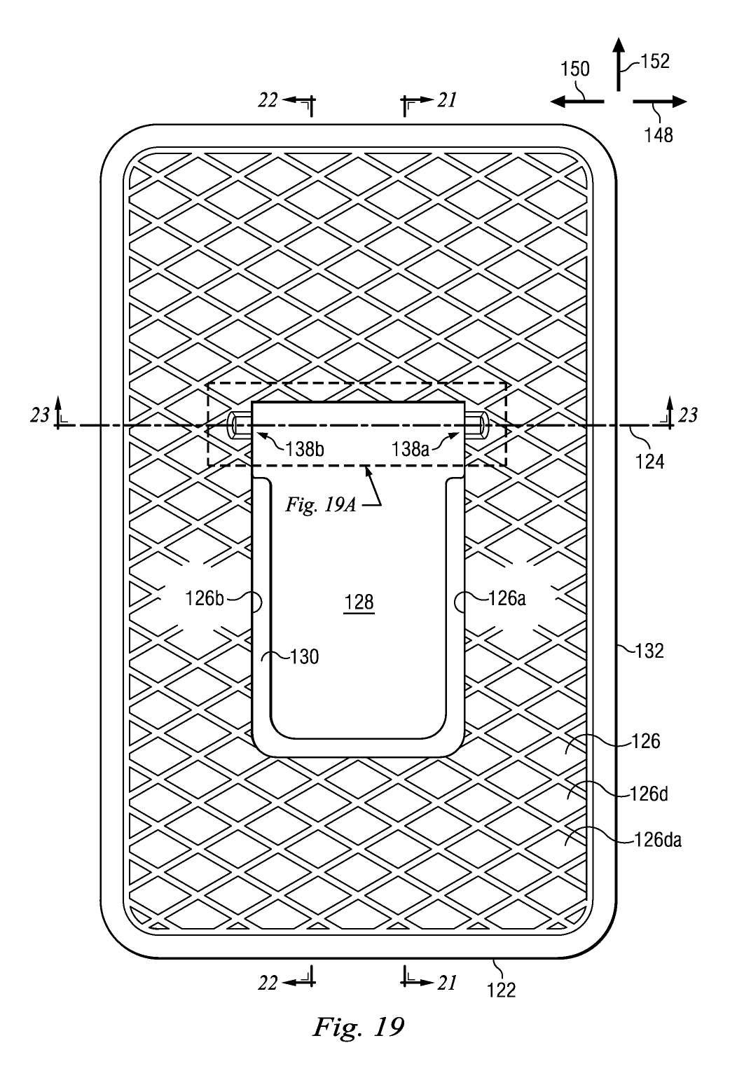

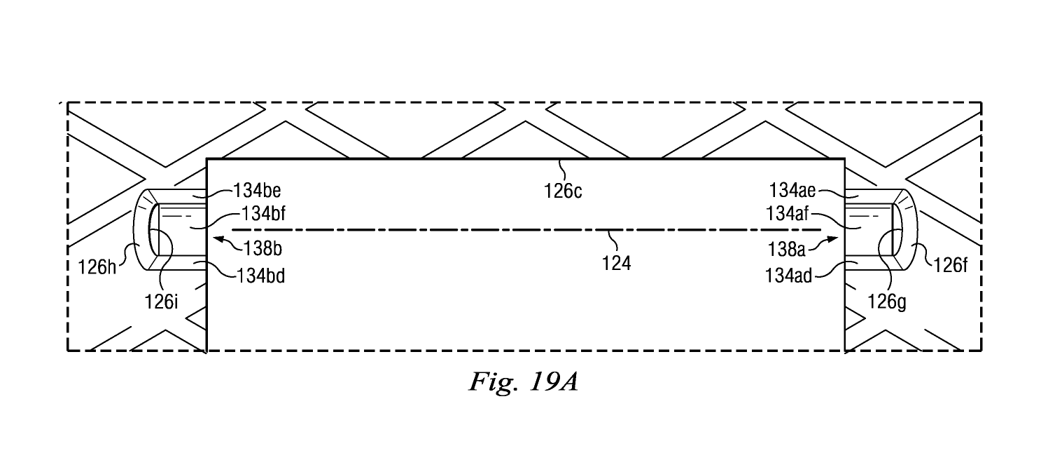

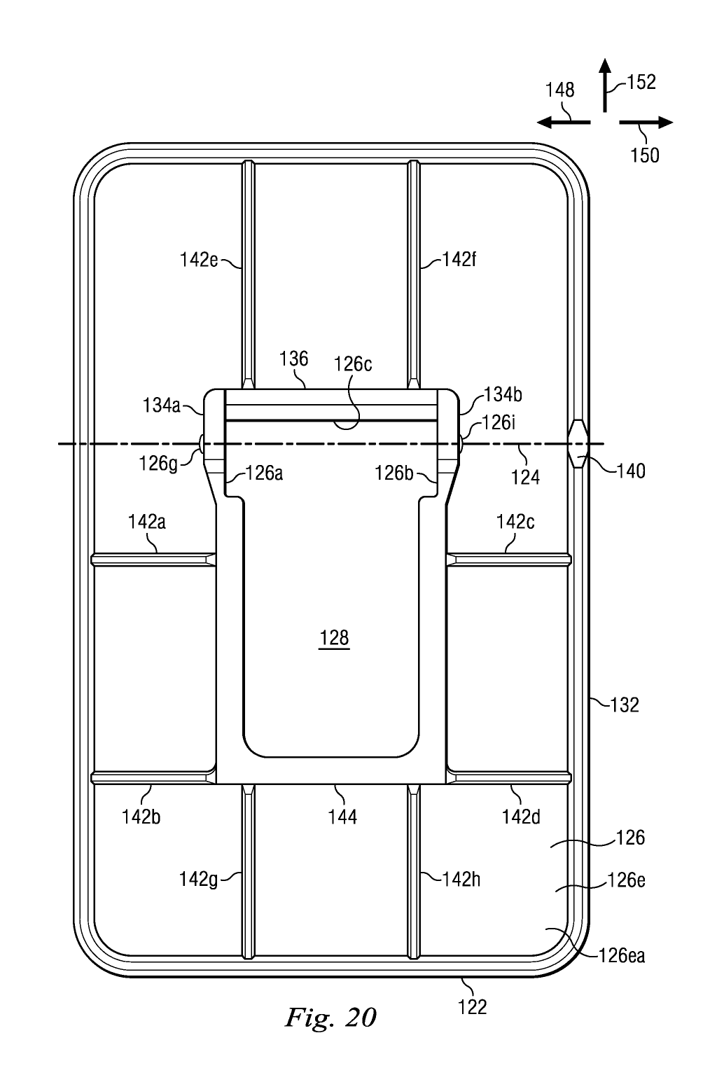

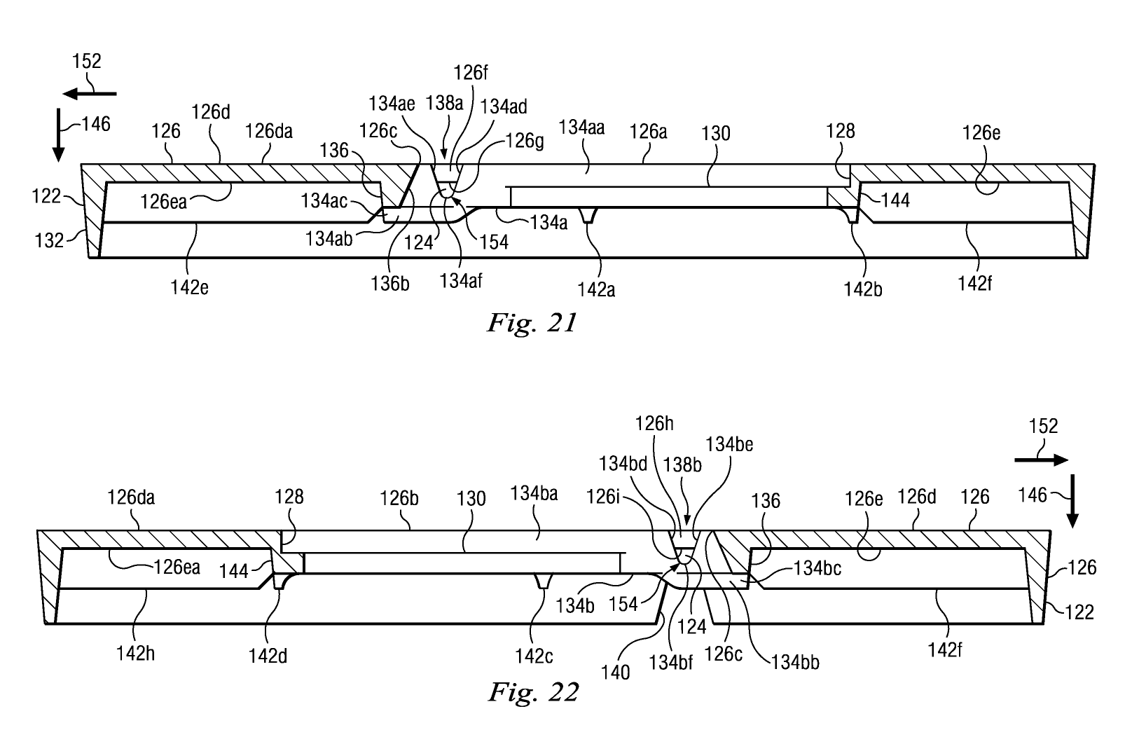

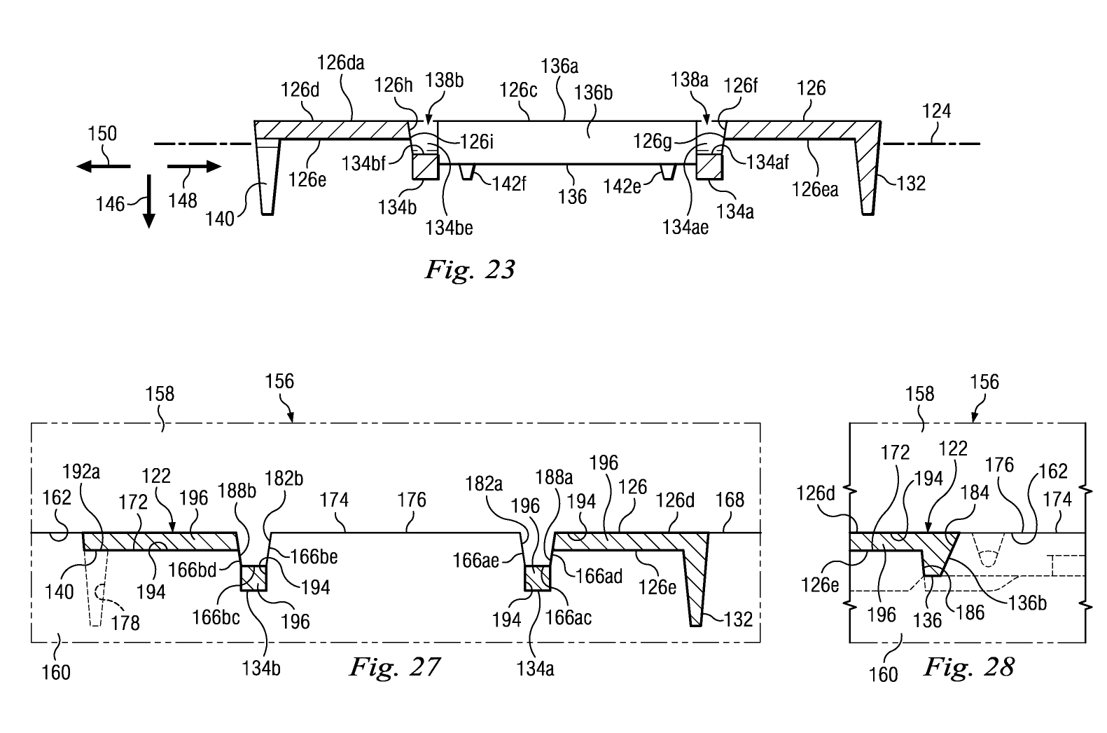

In an exemplary embodiment, as illustrated in FIGS. 19-23 with continuing reference to FIGS. 17A-18B, the wall 134a defines a vertically-extending surface 134aa, which is aligned with, and extends along, the edge 126a of the plate 126. As noted above, the wall 134a extends away from the plate 126 in a direction generally opposite the direction which the internal shoulder 130 faces. Thus, the wall 134a extends away from the plate 126 in a direction 146 (shown in FIGS. 21-23), which is generally perpendicular to the pivot axis 124. A recess 134ab is formed in the surface 134aa, and defines a vertically-extending surface 134ac. The wall 134b defines a vertically-extending surface 134ba, which is aligned with, and extends along, the edge 126a of the plate 126. As noted above, the wall 134b extends away from the plate 126 in a direction generally opposite the direction which the internal shoulder 130 faces. Thus, the wall 134b extends away from the plate 126 in the direction 146, which is generally perpendicular to the pivot axis 124. A recess 134bb is formed in the surface 134ba, and defines a vertically-extending surface 134bc. The wall 136 defines an angularly-extending surface 136b, which is aligned with, and extends along, the edge 126c of the plate 126. The angularly-extending surface 136b extends between the vertically-extending surfaces 134aa and 134ba of the walls 134a and 134b, respectively.

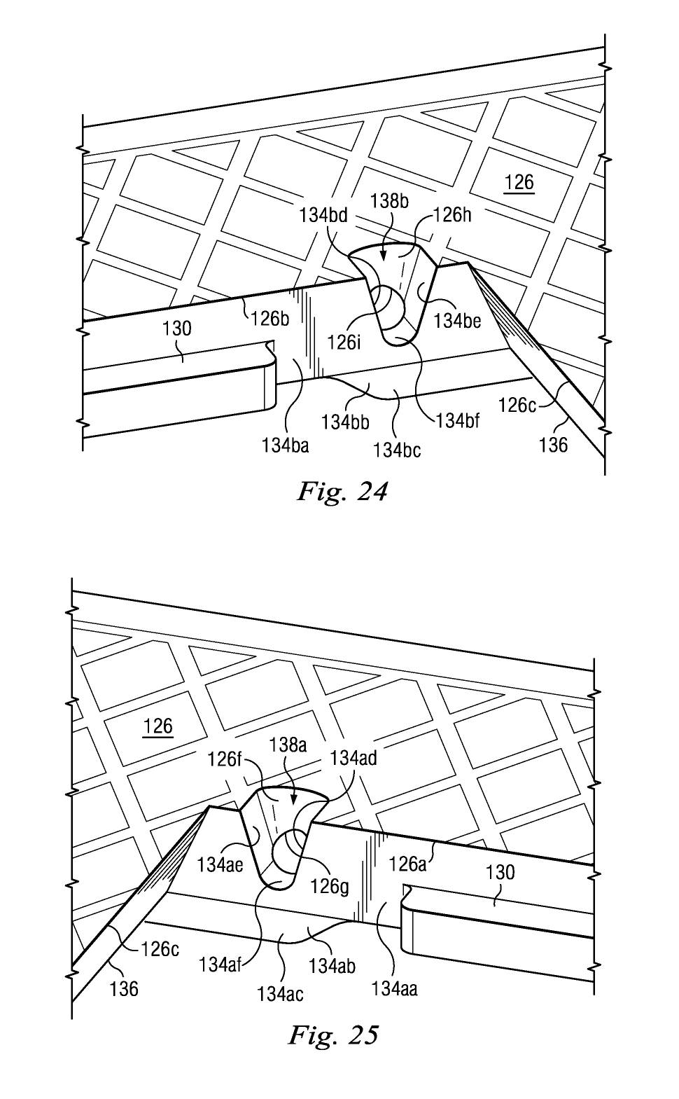

In an exemplary embodiment, as illustrated in FIGS. 19-25 with continuing reference to FIGS. 17A-18B, and as noted above, the opening 138a extends from the side 126d of the plate 126, through the plate 126, and into the wall 134a. More particularly, the opening 138a extends through the plate 126 in the direction 146. Further, the opening 138a extends through the wall 134a from the opening 128 in a direction 148, which is generally parallel to the pivot axis 124. As noted above, the opening 138b extends from the side 126d of the plate 126, through the plate 126, and into the wall 134b. More particularly, the opening 138b extends through the plate 126 in the direction 146. Further, the opening 138b extends through the wall 134b from the opening 128 in a direction 150, which is generally parallel to the pivot axis 124 and generally opposite to the direction 148.

Surfaces 134ad and 134ae of the wall 134a are defined by the opening 138a, and extend angularly inward and towards each other. The angularly-extending surface 134ae is spaced from the angularly-extending surface 134ad in a direction 152 (shown in FIGS. 21 and 22), which is generally perpendicular to each of the pivot axis 124 and the directions 146, 148 and 150. A concave surface 134af of the wall 134a is also defined by the opening 138a. At least a portion of the concave surface 134af extends between the distal ends of the surfaces 134ad and 134ae. In an exemplary embodiment, the concave surface 134af extends between, and joins, the distal ends of the surfaces 134ad and 134ae so that the surfaces 134ad, 134af and 134ae are generally continuous. At least a portion of the concave surface 134af is spaced from the surface 126ea and thus the side 126e of the plate 126 in the direction 146.

Surfaces 134bd and 134be of the wall 134b are defined by the opening 138b, and extend angularly inward and towards each other. The angularly-extending surface 134be is spaced from the angularly-extending surface 134bd in the direction 152. A concave surface 134bf of the wall 134b is also defined by the opening 138a. At least a portion of the concave surface 134bf extends between the distal ends of the surfaces 134bd and 134be. In an exemplary embodiment, the concave surface 134bf extends between, and joins, the distal ends of the surfaces 134bd and 134be so that the surfaces 134bd, 134bf and 134be are generally continuous. At least a portion of the concave surface 134bf is spaced from the surface 126ea and thus the side 126e of the plate 126 in the direction 146. The concave surface 134bf is also axially spaced from the concave surface 134af in the direction 150.

A surface 126f of the plate 126 is defined by the opening 138a. The surface 126f extends from the angularly-extending edge of the surface 134ad in a direction away from the opening 128, and curves back to the angularly-extending edge of the surface 134ae. An edge 126g of the surface 126f is also defined by the opening 138a, and thus also extends from the surface 134ad and curves back to the surface 134ae. A surface 126h of the plate 126 is defined by the opening 138b. The surface 126h extends from the angularly-extending edge of the surface 134bd in a direction away from the opening 128, and curves back to the angularly-extending edge of the surface 134be. An edge 126i of the surface 126h is also defined by the opening 138b, and thus also extends from the surface 134bd and curves back to the surface 134be. The concave surface 134af is axially spaced from the respective portions of the surface 126ea that are adjacent the edges 126g and 126i of the plate 126 and that are generally axially aligned along the pivot axis 124. The concave surface 134bf is also axially spaced from the respective portions of the surface 126ea that are adjacent the edges 126g and 126i of the plate 126 and that are generally axially aligned along the pivot axis 124.

An axially-extending passage 154 is defined by at least the surface 126ea, the concave surfaces 134af and 134bf, the surfaces 134ad and 134ae, and the surfaces 134bd and 134be. The passage 154 is generally coaxial with the pivot axis 124. The passage 154 includes the notch 140 and the openings 138a and 138b.

In an exemplary embodiment, the panel 122 is integrally formed and thus the plate 126, the internal shoulder 130, the flange 132, the walls 134a and 134b, and the ribs 142a-h, are integrally formed. In an exemplary embodiment, the panel 122 is a casting and thus is integrally formed of cast metal, such as ductile iron. In several exemplary embodiments, instead of, or in addition to cast metal, the panel 122 is integrally formed of one or more other materials such as, for example, one or more thermoplastic or thermoset materials.

In an exemplary embodiment, with continuing reference to FIGS. 17A-25, to place the apparatus 120 in its assembled condition as shown in FIGS. 17A, 17B and 18B, the access door 12 is positioned, relative to the panel 122, so that: each of the tabs 62a and 62b of the access door 12 is adjacent the edge 136a of the wall 136, the ears 66a and 66b of the access door 12 are adjacent the walls 134b and 134a, respectively, and the axially-extending passage 74 of the access door 12 is generally coaxial with the axially-extending passage 154 of the panel 122. The pin element 16 is passed through the notch 140 so that the non-hooked end portion 40 is inserted through the opening 138b of the panel 122, the passage 74 of the access door 12, and the opening 138a of the panel 122. Thus, the non-hooked end portion 40 is inserted through the passage 154 of the panel 122. The hooked end portion 38 of the pin element 16 prevents the pin element 16 from passing completely though the opening 138b of the panel 122. As a result, the rod portion 36 of the pin element 36 extends through the opening 138b of the panel 122, the passage 74 of the access door 12, and the opening 138a of the panel 122. Thus, the rod portion 36 of the pin element 16 extends through the passage 154 of the panel 122, thereby hingedly or pivotally coupling the access door 12 to the panel 122. The rod portion 36 of the pin element 16, the passage 74 of the access door 12, the openings 138a and 138b of the panel 122, and the passage 154 of the panel 122, are all generally coaxial with the pivot axis 124.

In operation, in an exemplary embodiment, with continuing reference to FIGS. 17A-25, after the apparatus 120 has been placed in its assembled condition as described above, the access door 12 pivots, relative to the panel 122, about the pivot axis 124. The access door 12 pivots between the closed position shown in FIG. 17A and the open position shown in FIG. 17B. When the access door 12 is in the closed position shown in FIG. 17A, the side 42b of the plate 42 of the access door 12 engages or nearly engages the shoulder 130, and/or the tabs 62a and 62b of the access door 12 engage or nearly engage the wall 136, thereby resisting any further pivoting of the access door 12 in a clockwise direction, as viewed in FIGS. 17A and 17B, after the access door 12 has been placed in the closed position shown in FIG. 17A. When the access door 12 is in the open position shown in FIG. 17B, the side 42a of the plate 42 of the access door 12 engages or nearly engages the panel 122 at the edge 126c, which is aligned with the edge 136a of the wall 136, thereby resisting any further pivoting of the access door 12 in a counterclockwise direction, as viewed in FIGS. 17A and 17B.

During the pivoting of the access door 12 relative to the panel 122, the respective shapes of the concave surfaces 134af and 134bf of the panel 122 minimize any resistance to the pivoting of the access door 12 about the rod portion 36 of the pin element 16, thereby facilitating the pivoting of the access door 12. Further, the positioning of the respective centers of curvature of the concave surfaces 134af and 134bf along the pivot axis 124 minimizes any resistance to the pivoting of the access door 12 about the rod portion 36 of the pin element 16, thereby facilitating the pivoting of the access door 12.

In several exemplary embodiments, before, during and/or after the above-described exemplary operation of the apparatus 120, the extension of the pin element 16 through the opening 138b of the panel 122, the passage 74 of the access door 12, and the opening 138a of the panel 122, and thus through the passage 154 of the panel 122, maintains the pivotal coupling between the access door 12 and the panel 122. For example, the extension of the pin element 16 between the surfaces 134bd and 134be, and between the surfaces 134ad and 134ae, resists any movement of the access door 12, relative to the pin element 16 and thus the panel 122, in the direction 152 or a direction opposite thereof, regardless of the pivot position of the access door 12. For another example, the extension of the pin element 16 between the side 126e of the plate 126 and the concave surfaces 134af and 134bf resists any movement of the access door 12, relative to the pin element 16 and thus the panel 122, in either the direction 146 or a direction opposite thereof, regardless of the pivot position of the access door 12.

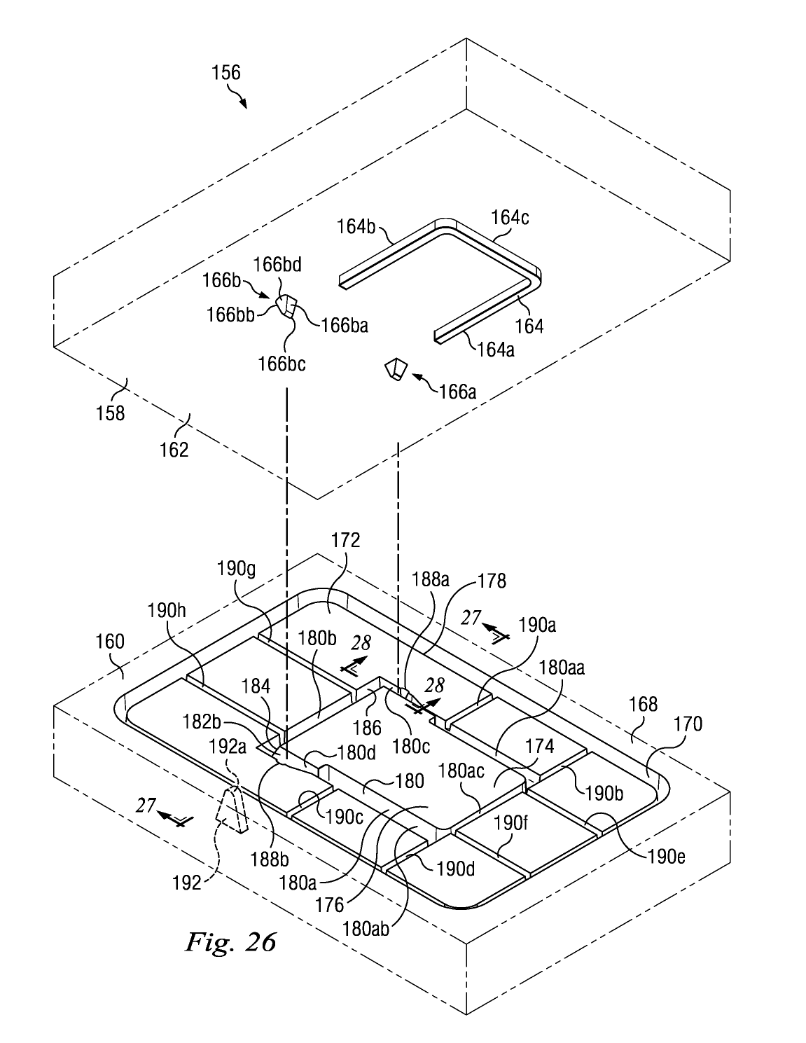

In an exemplary embodiment, as illustrated in FIGS. 26, 27 and 28 with continuing reference to FIGS. 17A-25, a horizontally-parted mold is generally referred to by the reference numeral 156 and includes an upper part, such as an upper half or cope 158, and a lower part, such as a lower half or drag 160. The mold 156 is used to manufacture the panel 122 of FIGS. 17A-25. The mold 156 does not include any cores such as, for example, hinge tubes or other cores, therein. In several exemplary embodiments, in addition to the cope 158 and the drag 160, the mold 156 includes, and/or employs, one or more gates, runner systems, etc., but does not include any cores, such as hinge tubes or other cores, therein. The broken line illustrations in FIG. 26 indicate that the mold 156 includes additional structure other than the cope 158 and the drag 160.

The cope 158 includes a horizontally-extending surface 162 from which a U-shaped projection 164 extends. The U-shaped projection 164 includes parallel-spaced portions 164a and 164b, and a transversely-extending portion 164c.

Spaced protrusions 166a and 166b extend from the surface 162. The protrusions 166a and 166b are aligned along a direction that is generally perpendicular to the parallel-spaced portions 164a and 164b. The spacing between the protrusions 166a and 166b is greater than the spacing between the parallel-spaced portions 164a and 164b. The protrusion 166b defines angularly-extending surfaces 166ba and 166bb, which extend angularly upward and towards each other from the surface 162. A convex curved surface 166bc joins the respective edges of the surfaces 166ba and 166bb that are opposite the surface 162. As a result, the surfaces 166ba, 166bb and 166bc are generally continuous. A convex curved surface 166bd joins the respective edges of the surfaces 166ba, 166bb and 166bc that are opposite the portion 164b. The convex surface 166bd extends angularly upward from the surface 162. An angularly-extending surface 166be (shown in FIG. 27) extends upward from the surface 162 to the surface 166bc, and between the surfaces 166ba and 166bb.

The protrusion 166a is symmetrically equivalent to the protrusion 166b about an axis that is disposed generally midway between, and is generally parallel to, the parallel-spaced portions 164a and 164b. Since the protrusion 166a is symmetrically equivalent to the protrusion 166b, the protrusion 166a will not be described in further detail. Reference numerals used to refer to the features of the protrusion 166a that are identical to the features of the protrusion 166b will correspond to the reference numerals used to refer to the features of the protrusion 166b, except that the prefix for the reference numerals used to refer to the features of the protrusion 166b, that is, 166b, will be replaced by the prefix of the protrusion 166a, that is, 166a.

The drag 160 defines a horizontally-extending outer surface 168 in which a generally rectangular recess 170 is formed. A horizontally-extending recessed surface 172 is defined by the rectangular recess 170. The horizontally-extending surfaces 168 and 172 are vertically offset from each other. As viewed in FIGS. 26 and 27, the surface 172 is vertically lower than the surface 168. A raised inner portion 174 of the drag 160 is defined by the rectangular recess 170. A horizontally-extending inner surface 176 is defined by the raised portion 174. The horizontally-extending inner surface 176 is generally coplanar with the horizontally-extending outer surface 168. Thus, as viewed in FIGS. 26-28, the surface 176 is vertically higher than the surface 172.

A generally rectangular outer channel 178 and a generally rectangular inner channel 180 are formed in the horizontally-extending surface 172. The inner channel 180 is formed around the raised portion 174. The inner channel 180 includes a U-shaped portion 180a having parallel-spaced portions 180aa and 180ab, and a transversely-extending portion 180ac. The inner channel 180 further includes another transversely-extending portion 180b, which is spaced in a generally parallel relation from the transversely-extending portion 180ac of the U-shaped portion 180a. The channel 180 further includes parallel-spaced portions 180c and 180d, which extend between the transversely-extending portion 180b and respective ends of the parallel-spaced portions 180aa and 180ab of the U-shaped portion 180a.

Angularly-extending surfaces 182a and 182b are defined by the portions 180c and 180d, respectively, of the inner channel 180 (the surface 182a is shown in FIG. 27). The surfaces 182a and 182b are symmetrically equivalent about an axis that is disposed generally midway between, and is generally parallel to, the parallel-spaced portions 180aa and 180ab of the U-shaped portion 180a of the inner channel 180. Each of the surfaces 182a and 182b extends angularly downward and away from the horizontally-extending inner surface 176 defined by the raised inner portion 174. Surfaces 184 and 186 are defined by the transversely-extending portion 180b of the inner channel 180.

A notch 188a is formed in a surface that is defined by the portion 180c of the inner channel 180 and that opposes the angularly-extending surface 182a. The notch 188a defines surfaces that are shaped to receive and mate with the surfaces 166aa, 166ab, 166ac and 166ad, respectively, of the protrusion 166a of the cope 158. Similarly, a notch 188b is formed in a surface that is defined by the portion 180d of the inner channel 180 and that opposes the angularly-extending surface 182b. The notch 188b defines surfaces that are shaped to receive and mate with the surfaces 166ba, 166bb, 166bc and 166bd, respectively, of the protrusion 166b of the cope 158. The notches 188a and 188b are aligned along a direction that is generally perpendicular to the portions 180aa and 180ab of the U-shaped portion 180a of the inner channel 180, and to the portions 180c and 180d of the inner channel 180.

Channels 190a and 190b are formed in the surface 172 and extend between the outer channel 178 and the portion 180aa of the U-shaped portion 180a of the inner channel 180. Channels 190c and 190d are formed in the surface 172 and extend between the outer channel 178 and the portion 180ab of the U-shaped portion 180a of the inner channel 180. Channels 190e and 190f are formed in the surface 172 and extend between the outer channel 178 and the portion 180ac of the U-shaped portion 180a of the inner channel 180. Channels 190g and 190h are formed in the surface 172 and extend between the outer channel 178 and the transversely-extending portion 180b of the inner channel 180.

A protrusion 192 extends upward within the outer channel 178. The protrusion 192 is aligned with the notches 188a and 188b along a direction that is generally perpendicular to the portions 180aa and 180ab of the U-shaped portion 180a of the inner channel 180, and to the portions 180c and 180d of the inner channel 180. The protrusion 192 is positioned in the outer channel 178 so that the notch 188b is positioned between the notch 188a and the protrusion 192. The protrusion 192 defines a convex curved surface 192a that is vertically offset from the surface 168. As viewed in FIGS. 26 and 27, the convex curved surface 192a is vertically lower than the surface 168.

In an exemplary embodiment, as illustrated in FIGS. 26, 27 and 28 with continuing reference to FIGS. 17A-25, to manufacture the panel 122, the panel 122 is cast using the mold 156 without a core in the mold 156. More particularly, the cope 158 is engaged with the drag 160 to form the mold 156. The mold 156 defines a cavity 194, portions of which are shown in FIGS. 27 and 28. Before, during and/or after the engagement between the cope 158 and the drag 160, the cavity 194 is filled with a material 196 such as, for example, molten metal. The cope 158 and the drag 160 engage each other, or at least are proximate to each other, along a horizontally-extending part line generally corresponding to the interface between the surface 162 of the cope 158 and the surfaces 168 and 176 of the drag 160.

Before, during and/or after the engagement between the cope 158 and the drag 160 and/or the filling of the cavity 194 with the material 196, the surface 162 engages the surface 176. As a result, the opening 128 of the panel 122 is at least partially formed. The U-shaped projection 164 extends within the U-shaped portion 180a of the inner channel 180, thereby at least partially forming the internal shoulder 130 of the panel 122.

As shown in FIGS. 27 and 28, before, during and/or after the engagement between the cope 158 and the drag 160 and/or the filling of the cavity 194 with the material 196, the protrusion 166a extends within the notch 188a, the surfaces of which receive and mate with the surfaces 166aa, 166ab, 166ac and 166ad of the protrusion 166a. As a result, the opening 138a of the panel 122 is formed, with the opening 138a extending through the plate 126 in the direction 146, and also extending through the wall 134a from the opening 128 in the direction 148. Likewise, the protrusion 166b extends within the notch 188b, the surfaces of which receive and mate with the surfaces 166ba, 166bb, 166bc and 166bd of the protrusion 166b. As a result, the opening 138b of the panel 122 is formed, with the opening 138b extending through the plate 126 in the direction 146, and also extending through the wall 134b from the opening 128 in the direction 150. The openings 138a and 138b are formed and are generally coaxial with the pivot axis 124 as cast. The protrusion 192 at least partially forms the notch 140 of the panel 122. The filling of the material 196 in the respective portions of the cavity 194 corresponding to the channels 190a, 190b, 190c, 190d, 190e, 190f, 190g and 190h at least partially forms the ribs 142a, 142b, 142c, 142d, 142g, 142h, 142e and 142f, respectively, of the panel 122. The filling of the material 196 in the portion of the cavity 194 extending between the surfaces 162 and 172 at least partially forms the plate 126 of the panel 122. The filling of the material 196 in the portion of the cavity 194 corresponding to the portions 180aa and 180c of the inner channel 180 at least partially forms the wall 134a of the panel 122. The filling of the material 196 in the portion of the cavity 194 corresponding to the portions 180ab and 180d at least partially forms the wall 134b of the panel 122. The filling of the material 196 in the portion of the cavity 194 corresponding to the transversely-extending portion 180b of the inner channel 180 at least partially forms the wall 136 of the panel 122. The filling of the material 196 in the portion of the cavity 194 corresponding to the portion 180ac of the U-shaped portion 180a of the inner channel 180 at least partially forms the wall 144 of the panel 122 (the wall 144 is not shown in FIGS. 27 and 28).

As a result of the above-described manufacture of the panel 122 by casting the panel 122 using the mold 156, the openings 128, 138a and 138b of the panel 122 are formed without a core in the mold 156. Therefore, in response to manufacturing the panel 122 by casting the panel 122 using the mold 156 without a core in the mold 156, the end portion 40 of the pin element 16 may be inserted along the pivot axis 124 and through the notch 140, the opening 138b and the opening 138a, as indicated in FIGS. 18A and 18B, without the need for any drilling or machining of the panel 122. The elimination of the need for post-casting drilling or machining of the panel 122 means the panel 122 is much less costly to manufacture. The panel 122 is ready to be hingedly or pivotally coupled to the access door 12, as cast.

An access door adapted to be pivotally coupled to a panel such as a meter box cover has been described, the access door at least partially defining a pivot axis about which the access door is adapted to pivot relative to the panel, the access door including a plate defining first and second sides; a ridge extending along the first side of the plate, the ridge including opposing first and second end portions; a channel formed in the second side of the plate, and extending into the ridge and axially therealong; a first opening extending through the plate and the first end portion of the ridge in a first direction that is generally perpendicular to the pivot axis, and also extending from the channel and through the first end portion of the ridge in a second direction that is generally parallel to the pivot axis; a second opening extending through the plate and the second end portion of the ridge in the first direction, and also extending from the channel and through the second end portion of the ridge in a third direction that is generally parallel to the pivot axis and opposite to the second direction; and an axially-extending passage including the channel, the first opening, and the second opening, wherein the passage is generally coaxial with the pivot axis and a pin element is adapted to extend through the passage to thereby pivotally couple the access door to the panel. In an exemplary embodiment, the access door includes first and second notches formed in the first side of the plate; wherein the first opening, the channel, and the second opening are axially positioned between the first and second notches; and wherein the passage further includes the first and second notches. In an exemplary embodiment, the first and second notches define axially-aligned first and second concave surfaces, respectively; wherein the channel defines a third concave surface, the third concave surface being axially positioned between the first and second concave surfaces; and wherein each of the first and second concave surfaces is spaced from the third concave surface, in a fourth direction that is perpendicular to the pivot axis and opposite to the first direction, so that the respective centers of curvature of the first, second and third concave surfaces lie generally along the pivot axis. In an exemplary embodiment, when the pin element extends through the passage to thereby pivotally couple the access door to the panel: the pin element is generally coaxial with each of the passage and the pivot axis; and the pin element extends through the first notch, the first opening, the channel, the second opening, and the second notch. In an exemplary embodiment, the access door includes first and second ears, each of which defines a first angularly-extending surface; first and second tabs, each of which defines a second angularly-extending surface; wherein the first concave surface defined by the first notch joins respective ends of the first angularly-extending surface of the first ear and the second angularly-extending surface of the first tab; wherein the second concave surface defined by the second notch joins respective ends of the first angularly-extending surface of the second ear and the second angularly-extending surface of the second tab; wherein the first angularly-extending surface of the first ear is spaced from the second angularly-extending surface of the first tab in a fifth direction that is generally perpendicular to each of the pivot axis and the first, second, third and fourth directions; and wherein the first angularly-extending surface of the second ear is spaced from the second angularly-extending surface of the second tab in the fifth direction. In an exemplary embodiment, the channel defines first and second angularly-extending surfaces that extend angularly inward toward each other from the second side of the plate; wherein the second angularly-extending surface is spaced from the first angularly-extending surface in a fourth direction that is generally perpendicular to each of the pivot axis and the first, second and third directions; and wherein the first and second end portions of the ridge define angularly-extending end faces, the end faces extending angularly towards each other from the first side of the plate.

An access door adapted to be pivotally coupled to a panel such as a meter box cover has been described, the access door at least partially defining a pivot axis about which the access door is adapted to pivot relative to the panel, the access door including a first surface; a second surface, wherein the second surface is axially spaced from the first surface and at least a portion of the second surface is spaced from the first surface in a first direction that is generally perpendicular to the pivot axis; a third surface; a fourth surface, wherein the fourth surface is spaced from the third surface in a second direction that is generally perpendicular to each of the pivot axis and the first direction; and an axially-extending passage defined by at least the first, second, third and fourth surfaces, the passage being generally coaxial with the pivot axis; wherein the first, second, third and fourth surfaces are integrally formed; and wherein, when a pin element extends through the passage to thereby pivotally couple the access door to the panel: the pin element extends between the first and second surfaces so that relative movement between the access door and the panel in the first direction is resisted; and the pin element extends between the third and fourth surfaces so that relative movement between the access door and the panel in the second direction is resisted. In an exemplary embodiment, the access door includes a plate defining first and second sides; a ridge extending along the first side of the plate, the ridge including the first surface and at least respective portions of the third and fourth surfaces; and a channel formed in the second side of the plate, and extending into the ridge and axially therealong to thereby define the first, third and fourth surfaces. In an exemplary embodiment, the access door includes a fifth surface, wherein the fifth surface is axially spaced from the first and second surfaces so that the first surface is axially positioned between the second and fifth surfaces, and wherein at least a portion of the fifth surface is spaced from the first surface in the first direction; wherein, when the pin element extends through the passage to thereby pivotally couple the access door to the panel, the pin element extends between the first and fifth surfaces so that relative movement between the access door and the panel in the first direction is further resisted. In an exemplary embodiment, the access door includes first and second notches formed in the first side of the plate; wherein the first and second notches define the second and fifth surfaces, respectively; wherein the first opening, the channel, and the second opening are axially positioned between the first and second notches; and wherein the passage further includes the first and second notches. In an exemplary embodiment, each of the first and second surfaces is concave; and wherein the at least a portion of the second surface is spaced from the first surface in the first direction so that the respective centers of curvature of the first and second surfaces lie generally along the pivot axis. In an exemplary embodiment, the access door includes a fifth surface, wherein the fifth surface is concave and axially spaced from the first and second surfaces so that the first surface is axially positioned between the second and fifth surfaces, and wherein at least a portion of the fifth surface is spaced from the first surface in the first direction so that the respective centers of curvature of the first, second and fifth surfaces lie generally along the pivot axis; and first and second notches formed in the first side of the plate; wherein the first and second notches define the second and fifth surfaces, respectively; wherein the first opening, the channel, and the second opening are axially positioned between the first and second notches; and wherein the passage further includes the first and second notches. In an exemplary embodiment, the access door includes first and second ears, each of which defines a first angularly-extending surface; first and second tabs, each of which defines a second angularly-extending surface; wherein the second surface defined by the first notch joins respective ends of the first angularly-extending surface of the first ear and the second angularly-extending surface of the first tab; wherein the fifth surface defined by the second notch joins respective ends of the first angularly-extending surface of the second ear and the second angularly-extending surface of the second tab; wherein the first angularly-extending surface of the first ear is spaced from the second angularly-extending surface of the first tab in the second direction; wherein the first angularly-extending surface of the second ear is spaced from the second angularly-extending surface of the second tab in the second direction; and wherein, when the pin element extends through the passage to thereby pivotally couple the access door to the panel: the pin element extends between the first angularly-extending surface of the first ear and the second angularly-extending surface of the first tab so that relative movement between the access door and the panel in the second direction is further resisted; and the pin element extends between the first angularly-extending surface of the second ear and the second angularly-extending surface of the second tab so that relative movement between the access door and the panel in the second direction is still further resisted.

A method has been described that includes manufacturing an access door adapted to be pivotally coupled to a panel via a pin element, the access door including a passage, wherein manufacturing the access door includes providing a mold; and casting the access door using the mold without a core in the mold; wherein, in response to casting the access door using the mold without a core in the mold: the passage is formed, and an end portion of the pin element is permitted to be inserted through the passage as cast to thereby pivotally couple the access door to the panel. In an exemplary embodiment, the method includes pivotally coupling the access door to the panel, the panel including axially-aligned first and second openings, wherein pivotally coupling the access door to the panel includes positioning the passage axially between the axially-aligned first and second openings; and inserting the end portion of the pin element through the first opening, the passage, and the second opening, to thereby pivotally couple the access door to the panel. In an exemplary embodiment, the mold includes first and second parts, which are adapted to engage, or at least be proximate to, each other along a part line; wherein the first part includes a first surface; and a rib extending from the first surface, the rib including a convex surface at its distal end, and first and second angularly-extending end faces that extend from the surface and angularly towards one another; wherein the second part includes a raised portion that defines a second surface; an axially-extending channel formed in the raised portion; first and second notches formed in the raised portion at opposing ends of the channel, respectively; first and second angularly-extending surfaces defined by the first and second notches, respectively; and third and fourth surfaces defined by the first and second notches, respectively, wherein the first and second angularly-extending surfaces extend from the second surface and angularly towards one another to the third and fourth surfaces, respectively; and wherein casting the access door using the mold without a core in the mold includes engaging the convex surface of the rib of the first part with the third and fourth surfaces of the second part; and engaging the first and second angularly-extending end faces of the first part with the first and second angularly-extending surfaces, respectively, of the second part. In an exemplary embodiment, in response to engaging the convex surface of the rib of the first part with the third and fourth surfaces of the second part and engaging the first and second angularly-extending end faces of the first part with the first and second angularly-extending surfaces, respectively, of the second part: a ridge is formed, the ridge including opposing first and second end portions; an axially-extending channel in the ridge is formed, the axially-extending channel defining a concave surface; a first opening is formed, the first opening extending through the first end portion of the ridge in a first direction that is generally perpendicular to the pivot axis, and also extending from the channel and through the first end portion of the ridge in a second direction that is generally parallel to the pivot axis; a second opening is formed, the second opening extending through the second end portion of the ridge in the first direction, and also extending from the channel and through the second end portion of the ridge in a third direction that is generally parallel to the pivot axis and opposite to the second direction; wherein the passage includes the channel and the first and second openings. In an exemplary embodiment, casting the access door using the mold without a core in the mold includes forming a plate; forming a ridge extending from the plate, the ridge including opposing first and second end portions; forming an axially-extending channel in the plate and the ridge; forming a first opening that extends through the plate and the first end portion of the ridge in a first direction that is generally perpendicular to the pivot axis, and that also extends from the channel and through the first end portion of the ridge in a second direction that is generally parallel to the pivot axis; and forming a second opening that extends through the plate and the first end portion of the ridge in the first direction, and that also extends from the channel and through the second end portion of the ridge in a third direction that is generally parallel to the pivot axis and opposite to the second direction. In an exemplary embodiment, the passage includes the channel and the first and second openings; and wherein the method further includes pivotally coupling the access door to the panel, the panel including axially-aligned openings, wherein pivotally coupling the access door to the panel includes positioning the passage axially between the axially-aligned first and second openings; and inserting the end portion of the pin element through one of the axially-aligned openings, the first opening, the passage, the second opening, and the other of the axially-aligned openings, to thereby pivotally couple the access door to the panel. In an exemplary embodiment, the access door further includes a plate defining first and second sides; a ridge extending along the first side of the plate, the ridge including opposing first and second end portions; a channel formed in the second side of the plate, and extending into the ridge and axially therealong; a first opening extending through the plate and the first end portion of the ridge in a first direction that is generally perpendicular to the pivot axis, and also extending from the channel and through the first end portion of the ridge in a second direction that is generally parallel to the pivot axis; and a second opening extending through the plate and the second end portion of the ridge in the first direction, and also extending from the channel and through the second end portion of the ridge in a third direction that is generally parallel to the pivot axis and opposite to the second direction; wherein the passage includes the channel, the first opening, and the second opening.

A panel to which an access door is adapted to be pivotally coupled has been described, the panel at least partially defining a pivot axis about which the access door is adapted to pivot relative to the panel, the panel including a plate defining first and second sides; a first opening formed through the plate and in which at least a portion of the access door is adapted to be disposed, the first opening defining opposed edges on the first side of the plate; first and second walls extending from the plate, the first and second walls defining first and second surfaces, respectively, the first and second surfaces being respectively generally aligned with the opposed edges defined by the first opening; a second opening extending through the plate and into the first wall in a first direction that is generally perpendicular to the pivot axis, the second opening also extending from the first opening and through the first wall in a second direction that is generally parallel to the pivot axis; a third opening extending through the plate and into the second wall in the first direction, the third opening also extending from the first opening and through the second wall in a third direction that is generally parallel to the pivot axis and opposite to the second direction; and an axially-extending passage including the second and third openings, wherein the passage is generally coaxial with the pivot axis and a pin element is adapted to extend through the passage to thereby pivotally couple the access door to the panel. In an exemplary embodiment, the second opening defines third and fourth surfaces, the fourth surface being spaced from the third surface in a fourth direction that is generally perpendicular to the pivot axis and each of the first and second directions; and wherein the third opening defines fifth and sixth surfaces, the sixth surface being spaced from the fifth surface in the fourth direction. In an exemplary embodiment, the second opening defines a seventh surface, at least a portion of the seventh surface being spaced from the second side of the plate in the first direction; and wherein the third opening defines an eighth surface, at least a portion of the eighth surface being spaced from the second side of the plate in the first direction. In an exemplary embodiment, the third and fourth surfaces extend angularly towards each other; wherein the seventh surface is generally concave and at least a portion of the seventh surface extends between respective ends of the third and fourth surfaces; wherein the fifth and sixth surfaces extend angularly towards each other; and wherein the eighth surface is generally concave and at least a portion of the eighth surface extends between respective ends of the fifth and sixth surfaces. In an exemplary embodiment, when the pin element extends through the passage to thereby pivotally couple the access door to the panel: the pin element extends between the third and fourth surfaces, and between the fifth and sixth surfaces, so that relative movement between the access door and the panel in the fourth direction is resisted; and the pin element extends between the second side of the plate and the seventh surface, and between the second side of the plate and the eighth surface, so that relative movement between the access door and the panel in the first direction is resisted.

A panel to which an access door is adapted to be pivotally coupled has been described, the panel at least partially defining a pivot axis about which the access door is adapted to pivot relative to the panel, the panel including a first surface; a second surface, wherein the second surface is axially spaced from at least a portion of the first surface, and at least a portion of the second surface is spaced from the first surface in a first direction that is generally perpendicular to the pivot axis; a third surface; a fourth surface, wherein the fourth surface is spaced from the third surface in a second direction that is generally perpendicular to each of the pivot axis and the first direction; an axially-extending passage defined by at least the first, second, third and fourth surfaces, the passage being generally coaxial with the pivot axis; wherein the first, second, third and fourth surfaces are integrally formed; wherein, when a pin element extends through the passage to thereby pivotally couple the access door to the panel: the pin element extends between the first and second surfaces so that relative movement between the access door and the panel in the first direction is resisted; and the pin element extends between the third and fourth surfaces so that relative movement between the access door and the panel in the second direction is resisted. In an exemplary embodiment, the panel includes a fifth surface, wherein the fifth surface is axially spaced from the second surface, the fifth surface is axially spaced from the at least a portion of the first surface, and at least a portion of the fifth surface is spaced from the first surface in the first direction; a sixth surface, wherein the sixth surface is axially spaced from the fourth surface; and a seventh surface, wherein the seventh surface is spaced from the sixth surface in the second direction; wherein the passage is defined by at least the first, second, third, fourth, fifth, sixth and seventh surfaces. In an exemplary embodiment, the panel includes a plate defining first and second sides; a first opening formed through the plate and in which at least a portion of the access door is adapted to be disposed, the first opening defining opposed edges on the first side of the plate, the opposed edges being spaced in a parallel relation. In an exemplary embodiment, the panel includes first and second walls extending from the plate, the first and second walls being spaced in a parallel relation, the first and second walls defining respective surfaces that are respectively generally aligned with the opposed edges defined by the first opening. In an exemplary embodiment, the panel includes a second opening extending through the plate and into the first wall in the first direction, the second opening also extending from the first opening and through the first wall in a third direction that is generally parallel to the pivot axis; and a third opening extending through the plate and into the second wall in the first direction, the third opening also extending from the first opening and through the second wall in a fourth direction that is generally parallel to the pivot axis and opposite to the third direction; wherein the axially-extending passage includes the second and third openings. In an exemplary embodiment, the second, third and fourth surfaces are defined by the second opening; and wherein the fifth, sixth and seventh surfaces are defined by the third opening.

A kit has been described that includes a panel, the panel defining a first pivot axis, the panel including a first plate; a first opening formed through the first plate, the first opening defining opposed edges of the first plate, the opposed edges being spaced in a parallel relation; first and second walls extending from the first plate, the first and second walls being spaced in a parallel relation, the first and second walls defining first and second surfaces, respectively, the first and second surfaces being respectively generally aligned with the opposed edges defined by the first opening; a second opening extending through the first plate and into the first wall in a first direction that is generally perpendicular to the first pivot axis, the second opening also extending from the first opening and through the first wall in a second direction that is generally parallel to the first pivot axis; a third opening extending through the first plate and into the second wall in the first direction, the third opening also extending from the first opening and through the second wall in a third direction that is generally parallel to the first pivot axis and opposite to the second direction; and an axially-extending first passage including the second and third openings, wherein the first passage is generally coaxial with the first pivot axis; and an access door adapted to be pivotally coupled to the panel, wherein the access door defines a second pivot axis and includes: a second plate defining first and second sides; a ridge extending along the first side of the second plate, the ridge including opposing first and second end portions; a channel formed in the second side of the second plate, and extending into the ridge and axially therealong; a fourth opening extending through the second plate and the first end portion of the ridge in a fourth direction that is generally perpendicular to the second pivot axis, and also extending from the channel and through the first end portion of the ridge in a fifth direction that is generally parallel to the second pivot axis; a fifth opening extending through the second plate and the second end portion of the ridge in the fourth direction, and also extending from the channel and through the second end portion of the ridge in a sixth direction that is generally parallel to the second pivot axis and opposite to the fifth direction; and an axially-extending second passage including the channel, the fourth opening, and the fifth opening, wherein the second passage is generally coaxial with the second pivot axis. In an exemplary embodiment, the kit includes a pin element adapted to extend through the first and second passages; wherein, when the pin element extends through the first and second passages: at least a portion of the access door is disposed in the first opening of the panel; the first passage, the second passage, the first pivot axis, and the second pivot axis are generally coaxial; and the access door is pivotally coupled to the panel so that the access door is permitted to pivot, relative to the panel and about the generally coaxial first and second pivot axes.

A method has been described that includes manufacturing a panel adapted to be pivotally coupled to an access door via a pin element, the panel at least partially defining a pivot axis about which the access door is adapted to pivot relative to the panel, the panel including first and second openings that are generally coaxial with the pivot axis, wherein manufacturing the panel includes providing a mold; and casting the panel using the mold without a core in the mold; wherein, in response to casting the panel using the mold without a core in the mold: the first and second openings are formed and are generally coaxial with the pivot axis as cast; and an end portion of the pin element is permitted to be inserted through the first and second openings as cast, the end portion being permitted to be inserted in a direction that is generally parallel to the pivot axis so that the pin element is generally coaxial with the pivot axis. In an exemplary embodiment, the method includes pivotally coupling the access door to the panel, the access door including axially-aligned third and fourth openings, wherein pivotally coupling the access door to the panel includes positioning the axially-aligned third and fourth openings axially between the first and second openings; and inserting the end portion of the pin element through the first opening, the third opening, the fourth opening, and the second opening, to thereby pivotally couple the access door to the panel. In an exemplary embodiment, the mold includes first and second parts, which are adapted to engage, or at least be proximate to, each other along a part line; wherein the first part includes a first surface; and first and second protrusions extending from the first surface, each of the first and second protrusions including first and second angularly-extending surfaces that extend angularly from the first surface and towards one another; a first convex curved surface that joins the respective distal edges of the first and second angularly-extending surfaces; and a second convex curved surface that extends angularly from the first surface and towards the first convex curved surface, the second convex curved surface joining respective edges of the first convex curved surface and the first and second angularly-extending surfaces; and wherein the second part includes first and second notches formed therein. In an exemplary embodiment, casting the panel using the mold without a core in the mold includes engaging the first protrusion with the first notch; and engaging the second protrusion with the second notch; wherein the first opening is at least partially formed in response to the engagement between the first protrusion and the first notch; and wherein the second opening is at least partially formed in response to the engagement between the second protrusion and the second notch. In an exemplary embodiment, the second part further includes a second surface; a recess formed in the second surface, the recess defining a third surface that is offset from the second surface; a channel formed in the third surface; and a raised portion surrounded by the channel, the raised portion defining a fourth surface that is generally coplanar with the second surface; wherein casting the panel using the mold without a core in the mold further includes engaging the first surface of the first part with the coplanar second and fourth surfaces of the second part; wherein a plate and a third opening extending therethrough are at least partially formed in response to the engagement between the first surface and the coplanar second and fourth surfaces, the plate defining first and second sides; wherein first and second walls are at least partially formed using the channel in response to the engagement between the first surface and the coplanar second and fourth surfaces, the first and second walls extending from the plate; and wherein the panel includes the plate, the third opening, and the first and second walls. In an exemplary embodiment, in response to casting the panel using the mold without a core in the mold: the first opening extends through the plate and into the first wall in a first direction that is generally perpendicular to the pivot axis, and also extends from the third opening and through the first wall in a second direction that is generally parallel to the pivot axis; and the second opening extends through the plate and into the second wall in the first direction, and also extends from the third opening and through the second wall in a third direction that is generally parallel to the pivot axis and opposite to the second direction. In an exemplary embodiment, the panel further includes a plate defining first and second sides; a third opening formed through the plate and in which at least a portion of the access door is adapted to be disposed, the third opening defining opposed edges on the first side of the plate; and first and second walls extending from the plate, the first and second walls defining first and second surfaces, respectively, the first and second surfaces being respectively generally aligned with the opposed edges defined by the third opening; wherein the first opening extends through the plate and into the first wall in a first direction that is generally perpendicular to the pivot axis, and also extends from the third opening and through the first wall in a second direction that is generally parallel to the pivot axis; and wherein the second opening extends through the plate and into the second wall in the first direction, and also extends from the third opening and through the second wall in a third direction that is generally parallel to the pivot axis and opposite to the second direction.

It is understood that variations may be made in the foregoing without departing from the scope of the disclosure.

In several exemplary embodiments, the elements and teachings of the various illustrative exemplary embodiments may be combined in whole or in part in some or all of the illustrative exemplary embodiments. In addition, one or more of the elements and teachings of the various illustrative exemplary embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “left,” “right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several exemplary embodiments, while different steps, processes, and procedures are described as appearing as distinct acts, one or more of the steps, one or more of the processes, and/or one or more of the procedures may also be performed in different orders, simultaneously and/or sequentially. In several exemplary embodiments, the steps, processes and/or procedures may be merged into one or more steps, processes and/or procedures. In several exemplary embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several exemplary embodiments have been described in detail above, the embodiments described are exemplary only and are not limiting, and those skilled in the art will readily appreciate that many other modifications, changes and/or substitutions are possible in the exemplary embodiments without materially departing from the novel teachings and advantages of the present disclosure. Accordingly, all such modifications, changes and/or substitutions are intended to be included within the scope of this disclosure as defined in the following claims. In the claims, any means-plus-function clauses are intended to cover the structures described herein as performing the recited function and not only structural equivalents, but also equivalent structures.

What is claimed is:

1. A panel to which an access door is adapted to be pivotally coupled, the panel at least partially defining a pivot axis about which the access door is adapted to pivot relative to the panel, the panel comprising:
a plate defining first and second sides;
a first opening formed through the plate and in which at least a portion of the access door is adapted to be disposed, the first opening defining opposed edges on the first side of the plate;
first and second walls extending from the plate, the first and second walls defining first and second surfaces, respectively, the first and second surfaces being respectively generally aligned with the opposed edges defined by the first opening;
a second opening extending through the plate and into the first wall in a first direction that is generally perpendicular to the pivot axis, the second opening also extending from the first opening and through the first wall in a second direction that is generally parallel to the pivot axis;
a third opening extending through the plate and into the second wall in the first direction, the third opening also extending from the first opening and through the second wall in a third direction that is generally parallel to the pivot axis and opposite to the second direction; and
an axially-extending passage comprising the second and third openings, wherein the passage is generally coaxial with the pivot axis and a pin element is adapted to extend through the passage to thereby pivotally couple the access door to the panel.

2. The panel of claim 1, wherein the second opening defines third and fourth surfaces, the fourth surface being spaced from the third surface in a fourth direction that is generally perpendicular to the pivot axis and each of the first and second directions; and
wherein the third opening defines fifth and sixth surfaces, the sixth surface being spaced from the fifth surface in the fourth direction.

3. The panel of claim 2, wherein the second opening defines a seventh surface, at least a portion of the seventh surface being spaced from the second side of the plate in the first direction; and
wherein the third opening defines an eighth surface, at least a portion of the eighth surface being spaced from the second side of the plate in the first direction.

4. The panel of claim 3, wherein the third and fourth surfaces extend angularly towards each other;
wherein the seventh surface is generally concave and at least a portion of the seventh surface extends between respective ends of the third and fourth surfaces;
wherein the fifth and sixth surfaces extend angularly towards each other; and
wherein the eighth surface is generally concave and at least a portion of the eighth surface extends between respective ends of the fifth and sixth surfaces.

5. The panel of claim 3, wherein, when the pin element extends through the passage to thereby pivotally couple the access door to the panel:
the pin element extends between the third and fourth surfaces, and between the fifth and sixth surfaces, so that relative movement between the access door and the panel in the fourth direction is resisted; and
the pin element extends between the second side of the plate and the seventh surface, and between the second side of the plate and the eighth surface, so that relative movement between the access door and the panel in the first direction is resisted.

6. A panel to which an access door is adapted to be pivotally coupled, the panel at least partially defining a pivot axis about which the access door is adapted to pivot relative to the panel, the panel comprising:
a first surface;
a second surface, wherein:
the second surface is axially spaced from at least a portion of the first surface, and
at least a portion of the second surface is spaced from the first surface in a first direction that is generally perpendicular to the pivot axis;
a third surface;
a fourth surface, wherein the fourth surface is spaced from the third surface in a second direction that is generally perpendicular to each of the pivot axis and the first direction;
an axially-extending passage defined by at least the first, second, third and fourth surfaces, the passage being generally coaxial with the pivot axis;
wherein the first, second, third and fourth surfaces are integrally formed;
wherein, when a pin element extends through the passage to thereby pivotally couple the access door to the panel:
the pin element extends between the first and second surfaces so that relative movement between the access door and the panel in the first direction is resisted; and
the pin element extends between the third and fourth surfaces so that relative movement between the access door and the panel in the second direction is resisted.

7. The panel of claim 6, further comprising:
a fifth surface, wherein:
the fifth surface is axially spaced from the second surface,
the fifth surface is axially spaced from the at least a portion of the first surface, and
at least a portion of the fifth surface is spaced from the first surface in the first direction;
a sixth surface, wherein the sixth surface is axially spaced from the fourth surface; and
a seventh surface, wherein the seventh surface is spaced from the sixth surface in the second direction;
wherein the passage is defined by at least the first, second, third, fourth, fifth, sixth and seventh surfaces.

8. The panel of claim 7, further comprising:
a plate defining first and second sides;
a first opening formed through the plate and in which at least a portion of the access door is adapted to be disposed, the first opening defining opposed edges on the first side of the plate, the opposed edges being spaced in a parallel relation.

9. The panel of claim 8, further comprising:
first and second walls extending from the plate, the first and second walls being spaced in a parallel relation, the first and second walls defining respective surfaces that are respectively generally aligned with the opposed edges defined by the first opening.

10. The panel of claim 9, further comprising:
a second opening extending through the plate and into the first wall in the first direction, the second opening also extending from the first opening and through the first wall in a third direction that is generally parallel to the pivot axis; and
a third opening extending through the plate and into the second wall in the first direction, the third opening also extending from the first opening and through the second wall in a fourth direction that is generally parallel to the pivot axis and opposite to the third direction;
wherein the axially-extending passage comprises the second and third openings.

11. The panel of claim 10, wherein the second, third and fourth surfaces are defined by the second opening; and
wherein the fifth, sixth and seventh surfaces are defined by the third opening.

12. A kit comprising:
a panel, the panel defining a first pivot axis, the panel comprising:
a first plate;
a first opening formed through the first plate, the first opening defining opposed edges of the first plate, the opposed edges being spaced in a parallel relation;
first and second walls extending from the first plate, the first and second walls being spaced in a parallel relation, the first and second walls defining first and second surfaces, respectively, the first and second surfaces being respectively generally aligned with the opposed edges defined by the first opening;
a second opening extending through the first plate and into the first wall in a first direction that is generally perpendicular to the first pivot axis, the second opening also extending from the first opening and through the first wall in a second direction that is generally parallel to the first pivot axis;
a third opening extending through the first plate and into the second wall in the first direction, the third opening also extending from the first opening and through the second wall in a third direction that is generally parallel to the first pivot axis and opposite to the second direction; and
an axially-extending first passage comprising the second and third openings, wherein the first passage is generally coaxial with the first pivot axis;
and
an access door adapted to be pivotally coupled to the panel, wherein the access door defines a second pivot axis and comprises:
a second plate defining first and second sides;
a ridge extending along the first side of the second plate, the ridge comprising opposing first and second end portions;
a channel formed in the second side of the second plate, and extending into the ridge and axially therealong;
a fourth opening extending through the second plate and the first end portion of the ridge in a fourth direction that is generally perpendicular to the second pivot axis, and also extending from the channel and through the first end portion of the ridge in a fifth direction that is generally parallel to the second pivot axis;
a fifth opening extending through the second plate and the second end portion of the ridge in the fourth direction, and also extending from the channel and through the second end portion of the ridge in a sixth direction that is generally parallel to the second pivot axis and opposite to the fifth direction; and
an axially-extending second passage comprising the channel, the fourth opening, and the fifth opening, wherein the second passage is generally coaxial with the second pivot axis.

13. The kit of claim 12, further comprising:
a pin element adapted to extend through the first and second passages;
wherein, when the pin element extends through the first and second passages:
at least a portion of the access door is disposed in the first opening of the panel;
the first passage, the second passage, the first pivot axis, and the second pivot axis are generally coaxial; and
the access door is pivotally coupled to the panel so that the access door is permitted to pivot, relative to the panel and about the generally coaxial first and second pivot axes.

14. A method comprising:
manufacturing a panel adapted to be pivotally coupled to an access door via a pin element, the panel at least partially defining a pivot axis about which the access door is adapted to pivot relative to the panel, the panel comprising first and second openings that are generally coaxial with the pivot axis, wherein manufacturing the panel comprises:
providing a mold; and
casting the panel using the mold without a core in the mold;
wherein, in response to casting the panel using the mold without a core in the mold:
the first and second openings are formed and are generally coaxial with the pivot axis as cast; and
an end portion of the pin element is permitted to be inserted through the first and second openings as cast, the end portion being permitted to be inserted in a direction that is generally parallel to the pivot axis so that the pin element is generally coaxial with the pivot axis.

15. The method of claim 14, further comprising:
pivotally coupling the access door to the panel, the access door comprising axially-aligned third and fourth openings, wherein pivotally coupling the access door to the panel comprises:
positioning the axially-aligned third and fourth openings axially between the first and second openings; and
inserting the end portion of the pin element through the first opening, the third opening, the fourth opening, and the second opening, to thereby pivotally couple the access door to the panel.

16. The method of claim 14, wherein the mold comprises:
first and second parts, which are adapted to engage, or at least be proximate to, each other along a part line;
wherein the first part comprises:
a first surface; and
first and second protrusions extending from the first surface, each of the first and second protrusions comprising:
first and second angularly-extending surfaces that extend angularly from the first surface and towards one another;
a first convex curved surface that joins the respective distal edges of the first and second angularly-extending surfaces; and
a second convex curved surface that extends angularly from the first surface and towards the first convex curved surface, the second convex curved surface joining respective edges of the first convex curved surface and the first and second angularly-extending surfaces; and
wherein the second part comprises first and second notches formed therein.

17. The method of claim 16, wherein casting the panel using the mold without a core in the mold comprises:
engaging the first protrusion with the first notch; and
engaging the second protrusion with the second notch;
wherein the first opening is at least partially formed in response to the engagement between the first protrusion and the first notch; and
wherein the second opening is at least partially formed in response to the engagement between the second protrusion and the second notch.

18. The method of claim 17, wherein the second part further comprises:
a second surface;
a recess formed in the second surface, the recess defining a third surface that is offset from the second surface;
a channel formed in the third surface; and
a raised portion surrounded by the channel, the raised portion defining a fourth surface that is generally coplanar with the second surface;
wherein casting the panel using the mold without a core in the mold further comprises engaging the first surface of the first part with the coplanar second and fourth surfaces of the second part;
wherein a plate and a third opening extending therethrough are at least partially formed in response to the engagement between the first surface and the coplanar second and fourth surfaces, the plate defining first and second sides;
wherein first and second walls are at least partially formed using the channel in response to the engagement between the first surface and the coplanar second and fourth surfaces, the first and second walls extending from the plate; and
wherein the panel comprises the plate, the third opening, and the first and second walls.

19. The method of claim 18, wherein, in response to casting the panel using the mold without a core in the mold:
the first opening extends through the plate and into the first wall in a first direction that is generally perpendicular to the pivot axis, and also extends from the third opening and through the first wall in a second direction that is generally parallel to the pivot axis; and
the second opening extends through the plate and into the second wall in the first direction, and also extends from the third opening and through the second wall in a third direction that is generally parallel to the pivot axis and opposite to the second direction.

20. The method of claim 14, wherein the panel further comprises:
a plate defining first and second sides;
a third opening formed through the plate and in which at least a portion of the access door is adapted to be disposed, the third opening defining opposed edges on the first side of the plate; and
first and second walls extending from the plate, the first and second walls defining first and second surfaces, respectively, the first and second surfaces being respectively generally aligned with the opposed edges defined by the third opening;
wherein the first opening extends through the plate and into the first wall in a first direction that is generally perpendicular to the pivot axis, and also extends from the third opening and through the first wall in a second direction that is generally parallel to the pivot axis; and
wherein the second opening extends through the plate and into the second wall in the first direction, and also extends from the third opening and through the second wall in a third direction that is generally parallel to the pivot axis and opposite to the second direction.
